(19) United States
(12) Patent Application Publication
(10) Pub. No.: US 2016/0119739 A1
(43) Pub. Date: Apr. 28, 2016

(54) DATA DELIVERY EMPLOYING PREEMPTIVE MUTUAL EXCHANGE OF THE DATA

(71) Applicant: QUALCOMM Incorporated, San Diego, CA (US)

(72) Inventors: Karl Georg Hampel, New York, NY (US); Vincent Douglas Park, Budd Lake, NJ (US); Junyi Li, Chester, NJ (US)

(21) Appl. No.: 14/693,500

(22) Filed: Apr. 22, 2015

Related U.S. Application Data
(60) Provisional application No. 62/068,536, filed on Oct. 24, 2014.

(51) Int. Cl. H04W 4/00; H04B 7/14; H04L 29/08; H04W 40/24

(52) U.S. Cl. CPC H04W 4/005; H04W 40/244; H04B 7/14; H04W 4/008; H04L 67/104; H04W 88/04

(57) ABSTRACT

In a scenario where peer devices (e.g., machine-to-machine devices, machine type communication devices, and so on) have limited transmission capabilities, the peer devices may upload data to another device. For example, data may be uploaded to a base station directly or via a relay device (e.g., a user equipment). Connectivity to the base station or relay device is not assured, however. To facilitate uploading of such data, the data is mutually exchanged between the peer devices. In this way, the data can be uploaded once at least one of the peer devices establishes connectivity to the base station or relay device.

### CROSS-REFERENCE TO RELATED APPLICATION(S)

This application claims priority to and the benefit of provisional patent application No. 62/068,536 filed in the U.S. patent office on Oct. 24, 2014, the entire content of which is incorporated herein by reference.

### BACKGROUND

1. Field of the Disclosure

Aspects of the disclosure relate generally to wireless communication, and more specifically, but not exclusively, to peer devices that mutually exchange data to facilitate delivery of the data to another device.

2. Description of Related Art

Machine-to-machine (M2M) communication or machine type communication (MTC) refers to data communication technologies that allow automated devices to communicate with one another without human intervention. For example, M2M and/or MTC may refer to communication from devices that integrate sensors or meters to measure or capture information and relay that information to a central server or application program that can make use of the information or present the information to humans interacting with the program or application. These devices may be called M2M devices, MTC devices and/or MTC user equipments (UEs). For convenience, these devices may simply be referred to as MTC devices in the discussion that follows.

MTC devices may be used to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. The market for MTC devices is expected to grow rapidly as industries such as automotive, security, healthcare, and fleet management employ MTC to increase productivity, manage costs, and/or expand customer services.

MTC devices may use a variety of wired and/or wireless communication technologies. For example, MTC devices may communicate with a network over various wide area network (WAN) technologies, such as Long Term Evolution (LTE), and/or over various local area network (LAN) technologies (e.g., IEEE 802.11 (Wi-Fi), IEEE 802.16 (WiMAX), etc.). MTC devices may also communicate with one another using various peer-to-peer technologies such as LTE-Direct (LTE-D), Bluetooth, ZigBee, and/or other ad-hoc or mesh network technologies. The expansion of multiple access wireless networks around the world has made it far easier for MTC communication to take place and has lessened the amount of power and time for information to be communicated between machines.

Typically, MTC devices are power efficient and low-cost. Therefore, these devices might be equipped with a radiofrequency (RF) amplifier that has relatively limited radiofrequency (RF) transmit power. Also, MTC devices may employ a transceiver that communicates via a relatively narrow frequency band (e.g., relative to the frequency band used for a WAN). As a result, MTC devices may have link budget challenges, particularly for up-link communication to a base station (e.g., an enhanced Node B (eNB)).

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

A device such as an Internet of Everything (IOE) device (e.g., an MTC device such as a sensor device) may, at some point in time, need to send a data message to a wide area network (WAN). For example, the data message may be destined for a server accessible via the WAN. In scenarios where the device is a low power device, the device might have downlink (DL) WAN coverage, but no (or minimal) uplink (UL) WAN coverage. Due to limited RF transmit power, either none or only a few of these low power devices may find sufficiently favorable channel conditions to reach the WAN directly.

For such scenarios, U.S. patent application Ser. Nos. 14/107,195 and 14/107,221 disclose solutions where a low power device opportunistically finds a nearby device (e.g., a user equipment (UE)) via a device-to-device (D2D) discovery mechanism and uses this nearby device as a relay to deliver the data message to the WAN and, ultimately, to the server. The WAN subsequently sends a delivery confirmation directly to the low power device, or to the low power device via the UE.

Due, in part, to the mobile nature of UEs, the probability of a low power device connecting to a UE may be very low. The disclosure relates in some aspects to techniques for enhancing the probability for WAN connectivity in such scenarios.

The disclosure relates in some aspects to a preemptive mutual exchange of data between peer devices. For example, the teachings herein may be advantageously employed in a scenario where an MTC device (e.g., a low power sensor device) enjoys downlink (DL) coverage but has only a random and small probabilistic chance to send data to the WAN on the uplink (UL). The latter may occur directly or via a relay.

In accordance with some aspects of the disclosure, MTC devices mutually exchange their data messages via a device-to-device (D2D) wireless air interface. Each MTC device caches the data messages received from its peers. When one of the MTC devices encounters an opportunity to connect to the WAN, that MTC device delivers all of the data messages that it has cached. The WAN may then send a confirmation message directly to the MTC devices on the DL. Advantageously, since each MTC device spreads its data across a larger number of MTC devices over an extended area, the probability for data delivery to the WAN is highly enhanced.

In some aspects, the teachings herein may be employed in a scenario where peer devices (e.g., machine-to-machine devices, machine type communication devices, and so on) with limited transmission capabilities have a need to upload data to a base station (e.g., either directly or via a relay device). As connectivity to the base station or relay device is not assured, the data is mutually exchanged between the peer devices. In this way, the data can be uploaded once at least one of the peer devices establishes connectivity to the base station or relay device.

In one aspect, the disclosure provides an apparatus configured for communication. The apparatus includes: a processing circuit configured to generate first data designated for upload to a wide area network (WAN); a receiver coupled to the processing circuit and configured to receive second data broadcast on a resource designated for peer devices, wherein the second data is designated for upload to the WAN; and a transmitter coupled to the processing circuit and configured to transmit the first data and the second data via a wireless communication channel.

Another aspect of the disclosure provides a method of communication. The method includes: generating first data designated for upload to a wide area network (WAN); receiving second data broadcast on a wireless communication resource designated for peer devices, wherein the second data is designated for upload to the WAN; and transmitting the first data and the second data via a wireless communication channel.

Another aspect of the disclosure provides an apparatus configured for communication. The apparatus including: means for generating first data designated for upload to a wide area network (WAN); means for receiving second data broadcast on a resource designated for peer devices, wherein the second data is designated for upload to the WAN; and means for transmitting the first data and the second data via a wireless communication channel.

Another aspect of the disclosure provides a non-transitory computer-readable medium storing computer-executable code, including code to: generate first data designated for upload to a wide area network (WAN); receive second data broadcast on a resource designated for peer devices, wherein the second data is designated for upload to the WAN; and transmit the first data and the second data via a wireless communication channel.

In one aspect, the disclosure provides an apparatus configured for communication that includes a memory device and a processing circuit coupled to the memory device. The processing circuit is configured to: determine whether connectivity for uploading data to a wide area network (WAN) is available; and send the data to at least one peer device via a peer-to-peer wireless communication channel as a result of the determination.

Another aspect of the disclosure provides a method of communication. The method includes: determining whether connectivity for uploading data to a wide area network (WAN) is available; and sending the data to at least one peer device via a peer-to-peer wireless communication channel as a result of the determination.

Another aspect of the disclosure provides an apparatus configured for communication. The apparatus including: means for determining whether connectivity for uploading data to a wide area network (WAN) is available; and means for sending the data to at least one peer device via a peer-to-peer wireless communication channel as a result of the determination.

Another aspect of the disclosure provides a non-transitory computer-readable medium storing computer-executable code, including code to: determine whether connectivity for uploading data to a wide area network (WAN) is available; and send the data to at least one peer device via a peer-to-peer wireless communication channel as a result of the determination.

In one aspect, the disclosure provides an apparatus configured for communication. The apparatus includes: a receiver configured to receive data from a plurality of peer devices via a first wireless communication channel; a processing circuit coupled to the receiver and configured to cache the received data; and a transmitter coupled to the processing circuit and configured to transmit the cached data to a wide area network (WAN) via a second wireless communication channel.

Another aspect of the disclosure provides a method of communication. The method includes: receiving data from a plurality of peer devices via a first wireless communication channel; caching the received data; and transmitting the cached data to a wide area network (WAN) via a second wireless communication channel.

Another aspect of the disclosure provides an apparatus configured for communication. The apparatus including: means for receiving data from a plurality of peer devices via a first wireless communication channel; means for caching the received data; and means for transmitting the cached data to a wide area network (WAN) via a second wireless communication channel.

Another aspect of the disclosure provides a non-transitory computer-readable medium storing computer-executable code, including code to: receive data from a plurality of peer devices via a first wireless communication channel; cache the received data; and transmit the cached data to a wide area network (WAN) via a second wireless communication channel.

In one aspect, the disclosure provides an apparatus configured for communication that includes a memory device and a processing circuit coupled to the memory device. The processing circuit is configured to: receive a message from a relay device via a wireless communication channel, wherein the message includes a plurality of data sets from a plurality of peer devices; process the message to identify each data set from each peer device; and individually process each of the data sets.

Another aspect of the disclosure provides a method of communication. The method includes: receiving a message from a relay device via a wireless communication channel, wherein the message includes a plurality of data sets from a plurality of peer devices; processing the message to identify each data set from each peer device; and individually processing each of the data sets.

Another aspect of the disclosure provides an apparatus configured for communication. The apparatus including: means for receiving a message from a relay device via a wireless communication channel, wherein the message includes a plurality of data sets from a plurality of peer devices; means for processing the message to identify each data set from each peer device; and means for individually processing each of the data sets.

Another aspect of the disclosure provides a non-transitory computer-readable medium storing computer-executable code, including code to: receive a message from a relay device via a wireless communication channel, wherein the message includes a plurality of data sets from a plurality of peer devices; process the message to identify each data set from each peer device; and individually process each of the data sets.

In one aspect, the disclosure provides an apparatus configured for communication that includes a memory device and a processing circuit coupled to the memory device. The processing circuit is configured to: receive signals at a first device; identify at least one second device belonging to at least one specified device class based on the received signals; and define a schedule for communication between the first device and the identified at least one second device.

Another aspect of the disclosure provides a method of communication. The method includes: receiving signals at a first device; identifying at least one second device belonging to at least one specified device class based on the received signals; and defining a schedule for communication between the first device and the identified at least one second device.

Another aspect of the disclosure provides an apparatus configured for communication. The apparatus including: means for receiving signals at a first device; means for identifying at least one second device belonging to at least one specified device class based on the received signals; and means for defining a schedule for communication between the first device and the identified at least one second device.

Another aspect of the disclosure provides a non-transitory computer-readable medium storing computer-executable code, including code to: receive signals at a first device; identify at least one second device belonging to at least one specified device class based on the received signals; and define a schedule for communication between the first device and the identified at least one second device.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates an example of a wireless communication system where a relay device relays data from several devices to another device.

FIG. 2 illustrates an example of a wireless communication system that employs mutual data exchange in accordance with some aspects of the disclosure.

FIG. 3 illustrates another example of the wireless communication system of FIG. 2 following an exchange of data.

FIG. 4 illustrates another example of the wireless communication system of FIG. 3 where data has been uploaded to a wide area network (WAN).

FIG. 5 illustrates an example of a process relating to mutual data exchange in accordance with some aspects of the disclosure.

FIG. 6 illustrates an example of a process for a device that supports mutual data exchange in accordance with some aspects of the disclosure.

FIG. 7 illustrates an example of a wireless communication system within which aspects of the disclosure may be implemented.

FIG. 8 illustrates an example of a wireless communication system implementing MTC service in accordance with some aspects of the disclosure.

FIG. 9 illustrates another example of a wireless communication system implementing MTC service in accordance with some aspects of the disclosure.

FIG. 10 illustrates examples of wireless communication for a machine type communication (MTC) device in accordance with some aspects of the disclosure.

FIG. 11 illustrates an example of a flow diagram for relaying communication of an MTC device through a relay device to a base station in accordance with some aspects of the disclosure.

FIG. 12 illustrates an example of another flow diagram for relaying communication of an MTC device through a relay device to a base station in accordance with some aspects of the disclosure.

FIG. 13 illustrates an example of a flow diagram for relaying communication of an MTC device through a relay device to a base station in accordance with some aspects of the disclosure.

FIG. 14 illustrates an example of another flow diagram for relaying communication of an MTC device through a relay device to a base station in accordance with some aspects of the disclosure.

FIG. 15 illustrates a block diagram of an example hardware implementation for an apparatus (e.g., an electronic device) that supports communication in accordance with some aspects of the disclosure.

FIG. 16 illustrates an example of a process for communication in accordance with some aspects of the disclosure.

FIG. 17 illustrates an example of a process relating to incrementing a hop count in accordance with some aspects of the disclosure.

FIG. 18 illustrates an example of a process relating to triggering data transmission in accordance with some aspects of the disclosure.

FIG. 19 illustrates another example of a process relating to triggering data transmission in accordance with some aspects of the disclosure.

FIG. 20 illustrates an example of a process relating to clearing memory in accordance with some aspects of the disclosure.

FIG. 21 illustrates another example of a process relating to clearing memory in accordance with some aspects of the disclosure.

FIG. 22 illustrates a block diagram of another example hardware implementation for an apparatus (e.g., an electronic device) that supports communication in accordance with some aspects of the disclosure.

FIG. 23 illustrates an example of a process relating to data exchange in accordance with some aspects of the disclosure.

FIG. 24 illustrates a block diagram of another example hardware implementation for an apparatus (e.g., an electronic device) that supports communication in accordance with some aspects of the disclosure.

FIG. 25 illustrates an example of a process relating to relaying data in accordance with some aspects of the disclosure.

FIG. 26 illustrates a block diagram of another example hardware implementation for an apparatus (e.g., an electronic device) that supports communication in accordance with some aspects of the disclosure.

FIG. 27 illustrates an example of a process relating to processing messages in accordance with some aspects of the disclosure.

FIG. 28 illustrates an example of a process relating to generating acknowledgements in accordance with some aspects of the disclosure.

FIG. 29 illustrates a block diagram of another example hardware implementation for an apparatus (e.g., an electronic device) that supports communication in accordance with some aspects of the disclosure.

FIG. 30 illustrates an example of a process for defining a schedule in accordance with some aspects of the disclosure.

FIG. 31 illustrates an example of a wireless communication network within which aspects of the disclosure may be implemented.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In some scenarios, an MTC device, an M2M device, an IOE device, a sensor, or some other device (which may be referred to herein, for convenience, as an MTC device), has downlink reachability from a WAN, but does not have enough RF transmission power to reach the WAN on an uplink channel. Such a device may be mobile or stationary.

The MTC device can send data to a server via the WAN by opportunistically using a UE as a relay as disclosed in U.S. patent application Ser. Nos. 14/107,195 and 14/107,221, the entirety of each of which is incorporated by reference herein. The MTC device may find the UE via a narrowband D2D discovery mechanism and establish a connection to the UE, while the UE establishes a connection to the WAN (e.g., via a base station such as an LTE eNB). In this manner, the MTC device can communicate with the WAN via the UE relay, authenticate itself to the WAN, deliver the data message to the server, and receive a confirmation from the server. To this end, the MTC device may be time-synchronized with the WAN, and may periodically wake up to use one or more channels (e.g., a discovery channel, a paging channel, a traffic channel, and an acknowledgement channel) defined for the WAN.

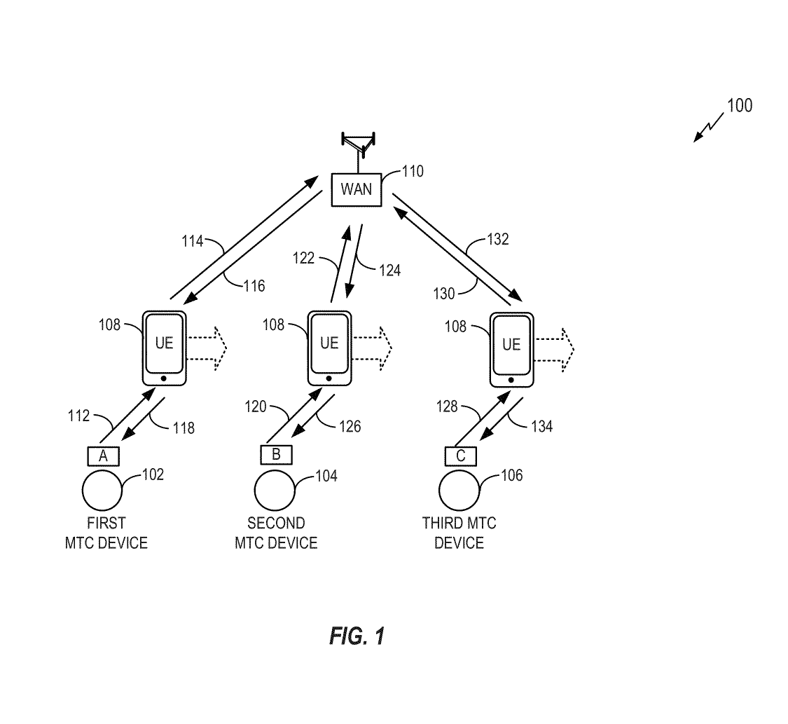

FIG. 1 illustrates a communication system 100 that employs such a relay scheme. Here, a first MTC device 102, a second MTC device 104, and a third MTC device 106 use a UE 108 to sequentially upload data messages to a WAN 110. As indicated by the dashed arrows, the UE 108 is moving from left to right from the view of FIG. 1.

Initially, the first MTC device 102 uploads a data message A to the WAN 110 via the UE 108. Here, the UE 108 establishes a connection with the WAN 110, thereby enabling the first MTC device 102 to send data to the WAN via uplink communication (represented by a first set of lines 112 and 114) and receive responses via downlink communication (represented by a second set of lines 116 and 118). After the data transfer completes, the UE 108 may tear down the connection to the WAN 110 (e.g., to conserve resources).

Subsequently (e.g., after the UE 108 moves), the second MTC device 104 uploads a data message B to the WAN 110 via the UE 108. Again, the UE 108 establishes a connection with the WAN 110, thereby enabling the second MTC device 104 to send data to the WAN via uplink communication (represented by a third set of lines 120 and 122) and receive responses via downlink communication (represented by a fourth set of lines 124 and 126). After the data transfer completes, the UE 108 may tear down the connection to the WAN 110.

Then (e.g., after the UE 108 moves again), the third MTC device 106 uploads a data message C to the WAN 110 via the UE 108. The UE 108 establishes a connection with the WAN 110, thereby enabling the third MTC device 106 to send data to the WAN via uplink communication (represented by a fifth set of lines 128 and 130) and receive responses via downlink communication (represented by a sixth set of lines 132 and 134). After this data transfer completes, the UE 108 may tear down the connection to the WAN 110.

It is also possible that an MTC device encounters favorable channel conditions to the WAN, which allows the MTC device to directly connect to the WAN and upload a data message. This may occur, for example, if the MTC device is placed in or is moved into close vicinity to a base station.

In both of the above scenarios, WAN-connectivity is an opportunistic event. The disclosure relates in some aspects to enhancing the probability that such an opportunistic event will occur. MTC devices residing in sufficient proximity to each other can help each other by mutually exchanging their data messages via a D2D wireless channel, whereby each MTC device caches data messages it receives from its peers.

For this purpose, each MTC device broadcasts its own data message and re-broadcasts data messages it receives from peers. The rebroadcast scheme can be based on flooding or it may adhere to a routing scheme that MTC devices may have established over time due to a listening and learning procedure, for instance.

Periodically, each MTC device evaluates UL connectivity to the WAN. This can includes a procedure where the MTC device searches for a UE relay as discussed in U.S. patent application Ser. Nos. 14/107,195 and 14/107,221. This can also include evaluation of a direct UL channel to the WAN.

As soon as one of these MTC devices obtains WAN connectivity, the MTC device delivers its own data message as well as the data messages received from the MTC device's peers. The WAN may send an acknowledgement for the data message reception directly to the MTC devices via a broadcast message.

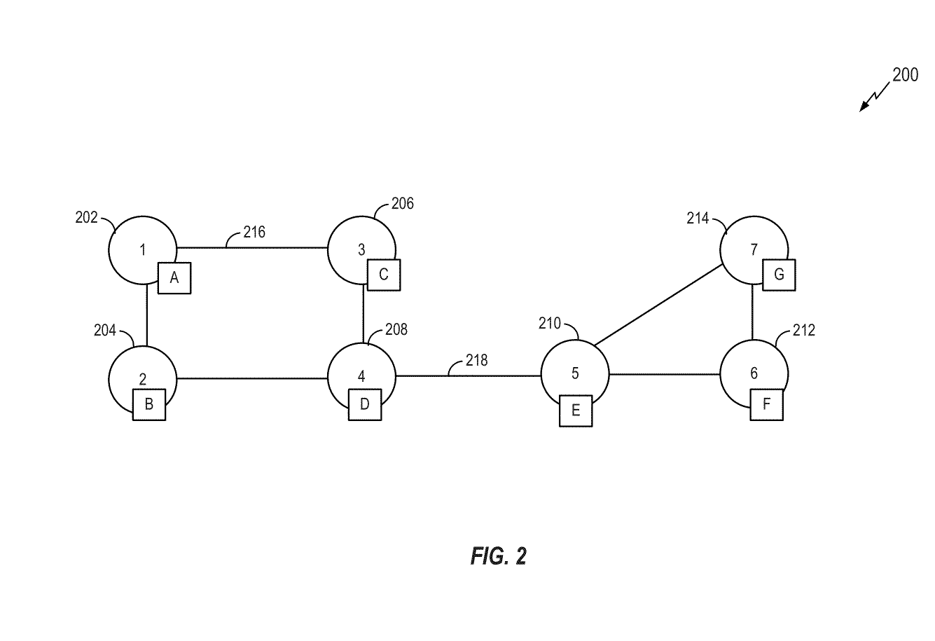

FIG. 2 illustrates a communication network 200 that employs a mutual exchange scheme in accordance with the teachings herein. The network 200 can be implemented according to various network technologies including, without limitation, fifth generation (5G) technology, fourth generation (4G) technology, third generation (3G) technology, and other network architectures. Thus, various aspects of the disclosure may be extended to networks based on Long Term Evolution (LTE), LTE-Advanced (LTE-A) (in FDD, TDD, or both modes), Universal Mobile Telecommunications System (UMTS), Global System for Mobile Communications (GSM), Code Division Multiple Access (CDMA), Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In FIG. 2, a first MTC device 202, a second MTC device 204, a third MTC device 206, a fourth MTC device 208, a fifth MTC device 210, a sixth MTC device 212, and a seventh MTC device 214 each have a data message (A, B, C, D, E, F, and G respectively) to upload to a WAN. The lines (e.g., the lines 216 and 218) interconnecting the MTC devices indicate mutual connectivity via D2D communication.

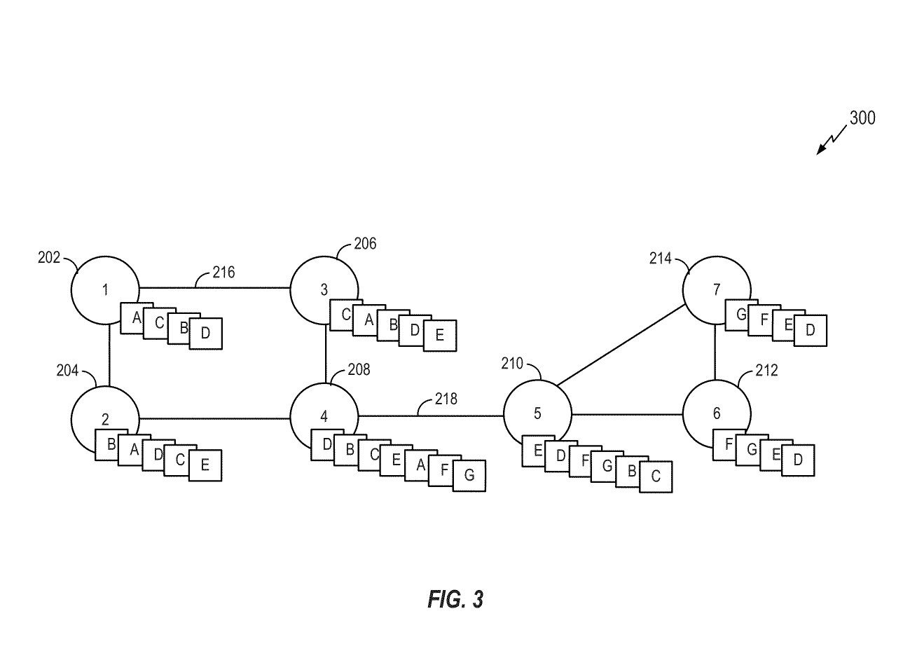

The diagram 300 in FIG. 3 illustrates the network 200 after D2D communication among the MTC devices. Each MTC device has cached a number of peer messages on top of its own. For example, the first MTC device 202 may have sent its data message (A) to the third MTC device 206 via the line 216, while the third MTC device 206 may have sent its data message (C) to the first MTC device 202 via the line 216. Similarly, the fourth MTC device 208 may have sent its data message (D) along with the data messages (A, B, and C) that the fourth MTC device 208 acquired from its neighbors to the fifth MTC device 210 via the line 218. Conversely, the fifth MTC device 210 may have sent its data message (E), along with the data messages (F and G) that the fifth MTC device 210 acquired from its neighbors, to the fourth MTC device 208 via the line 218.

In this example, propagation of messages was limited to two hops. Other hop limits (e.g., one, three, four, etc.) may be employed in other implementations.

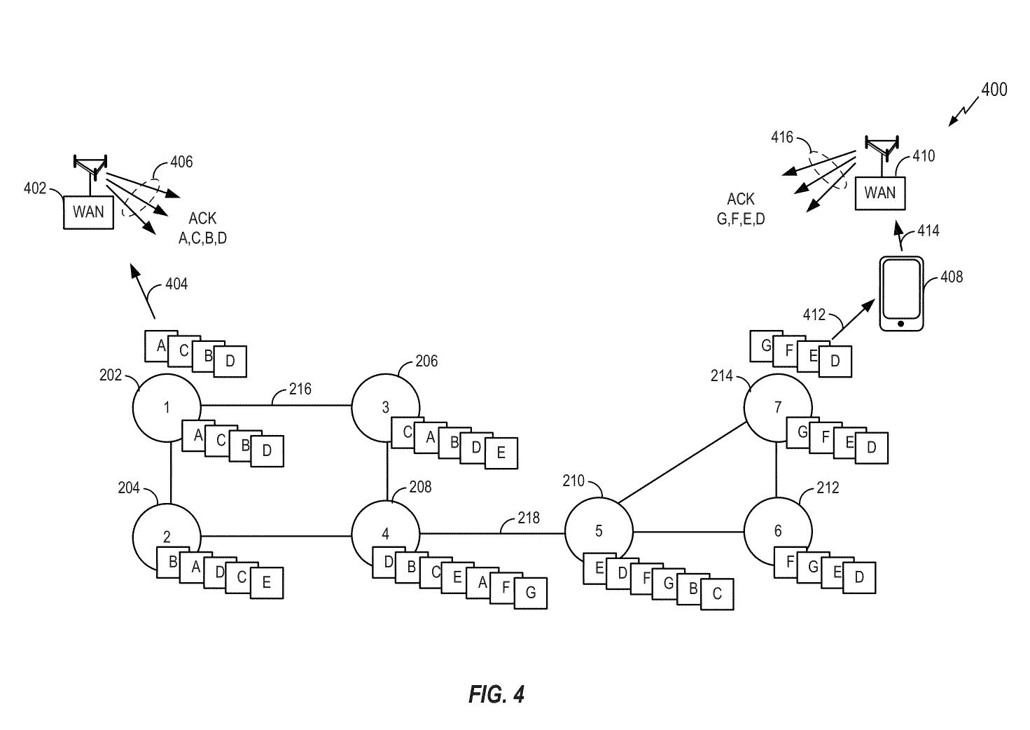

The diagram 400 in FIG. 4 illustrates the network 200 where two of the MTC devices have obtained connectivity to a WAN.

The first MTC device 202 has established a direct channel to a WAN 402. Accordingly, the first MTC device 202 sends its cached messages (A, C, B, and D) to the WAN 402 (e.g., for delivery to a server, not shown) as represented by the arrow 404. The WAN 402 broadcasts acknowledgements for the message IDs it has received as represented by ACK A, C, B, D 406.

The seventh MTC device 214 uses a relay device 408 (e.g., a UE) to upload data messages to a WAN 410 (e.g., for delivery to a server, not shown). Initially, the seventh MTC device 214 sends its cached messages (G, F, E, and D) to the relay device 408 as represented by the arrow 412. The relay device 408 then sends these messages (G, F, E, and D) to the WAN 410 as represented by the arrow 414. The WAN 410 broadcasts acknowledgements for the message IDs it has received as represented by ACK G, F, E, D 416.

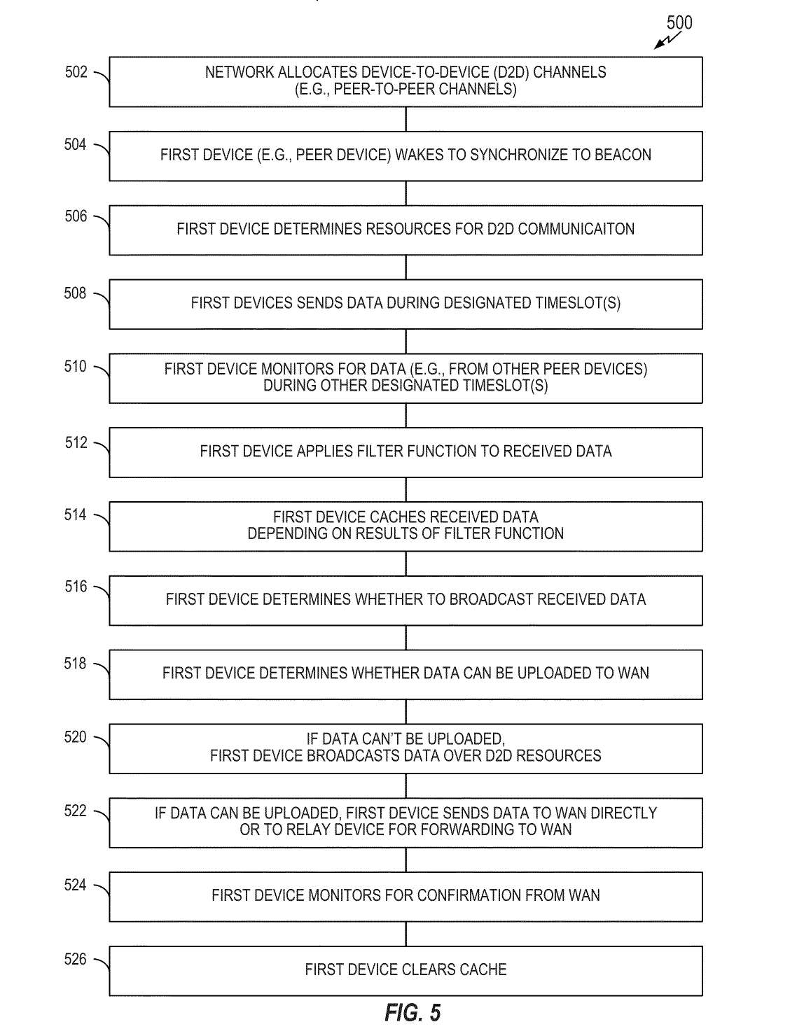

With the above in mind, FIG. 5 illustrates an example of a process 500 for data exchange-based communication in accordance with some aspects of the disclosure. In some aspects, the process 500 may be implemented by any suitable apparatuses capable of supporting communication-related operations.

At block 502, a network allocates device-to-device (D2D) channels (e.g., peer-to-peer channels). Time slots or other resources (e.g., frequency bands) used for communication between MTC devices and communication between an MTC device and a relay device may be defined in various ways. In some implementations, these resources are specified by the network. For example, a base station or some other network entity may specify the resources to be used for discovery, paging, data transmission, acknowledgement, and so on. As another example, these resources may be defined in a distributed manner (e.g., via negotiation between devices that will use the resources).

In some scenarios, orthogonal resources (e.g., with respect to other communication in a cell) may be specified for D2D communication. For example, different time slots may be allocated for discovery, paging, data transmission, etc., and/or different frequency bands may be allocated for discovery, paging, data transmission, etc. Also, orthogonal resources may be allocated for communication by different devices. For example, different time slots and/or different frequency bands may be allocated for communication among different pairs of devices.

In some implementations, the resources may be grouped together (e.g., in time and/or frequency) to make it easier for a device to listen to messages over the different resources (e.g., during a wake period for the device).

At block 504, a first device wakes (e.g., transitions from a low power state to a higher power state) to synchronize to a WAN beacon. For example, an MTC device may periodically transition from a low power state to a higher power state at certain times to monitor for beacons and other signals transmitted by any nearby base stations.

In every wake-up period, a set of time slots is allocated for D2D communication among the MTC devices, opportunistic connection establishment to the WAN, and delivery confirmation by the WAN. Assigning these time slots with sufficiently small duty cycle reduces the power consumption by the MTC devices. The time slots may be allocated by the WAN beacon, for instance.

At block 506, the first device determines the resources to be used for D2D communication. For example, the first device may identify the resources specified by the network. As another example, the first device may select a subset of allocated resources.

At block 508, the first device sends data during one or more timeslots designated for sending this data. For example, from the set of time slots allocated for D2D communication, each MTC device uses one of these time slots to broadcast its own data message. This time slot may be assigned by the WAN or selected by the MTC device. The selection scheme may follow a deterministic algorithm or a random algorithm.

The data message may contain a message-specific ID. The data message may also include a separate identifier for the message originator. For example, a data message may include an indication of the identity of the data source (e.g., a sensor ID). This allows the WAN to authenticate the originator of the data message.

A data message may include an indication of a destination (e.g., a destination address such as an IP address). This allows the WAN to deliver the data.

The MTC device may further insert an authenticator to its own message, which can be verified by its peers and/or the network. A data message may include an authenticator which is based on a shared key between the MTC device and another device (e.g., a relay device). This information may be based on public key infrastructure. In this case, the MTC device may include the public key, a public key chain, or a pointer to a public key that the other device (e.g., the relay device) may hold cached.

A data message may be encrypted and include an authenticator. Such security protection may be based on credentials shared between the MTC device and the WAN. This information allows a peer and/or the WAN to verify the integrity and authenticity of the message, and to eventually decrypt it.

A data message may include a time stamp. The time stamp can include information about the expiry of the message. Such a time stamp can indicate, for example, the delay tolerance (e.g., an expiry time) for the message. Evaluation of this time stamp may set another trigger condition for the UE to deliver the cached messages to the WAN.

A data message may further include a hop count. In this way, propagation of data throughout the peer device network can be controlled.

At block 510, the first device monitors for data during at least one other time slot. For example, an MTC device may monitor the D2D channel for transmissions by other MTC devices. Thus, in those time slots of the allocated set of time slots when the MTC device does not broadcast data, the MTC device may listen to the broadcast of peer MTC devices.

At block 512, the first device applies a filter function to any data that was received at block 510. For example, upon reception of a broadcast message, the MTC device applies a filter function which decides if the data message should be dropped or cached. This filter function may include evaluation of a message authenticator. The filter function may also check to see if the particular message has already been cached, or if sufficient space is available on the cache. The filter function may further include evaluation of the hop count and comparison to a maximum hop count value.

At block 514, depending on the results of the filter function, the first device may cache the received data, discard it, or take some other action. For example, if the data message passes the filter function, the MTC device may add the data message to a cache of data messages.

At block 516, in the event the received data is cached, the first device determines whether to broadcast the data. For example, if the MTC device has a new data message cached, the MTC device may decide to rebroadcast this data message in one of the time slots of the set allocated for D2D communication. The decision may include factors such as, for example, the availability of time slots for broadcast in the set or specific forwarding rules for this particular message. In general, a forwarding rule indicates how (e.g., whether or when, etc.) a message is to be forwarded. Non-limiting examples of forwarding rules include a hop count for a message, a message expiry time, or types of entities to which the message should be forwarded. As discussed herein, in some aspects, a hop count relates to the maximum number of hops that a message is to be forwarded. For example, a maximum hop limit of two may indicate that a message can be forwarded up to two hops away from the source. Thus, an MTC device that receives a message that already has a hop count of two would not forward the message in this case. If the message includes a hop count, the MTC device may increment this hop count prior to rebroadcasting the message.

At block 518, the first device determines whether data can be uploaded to a WAN. For example, in a separate set of time slots, the MTC device may attempt to connect to the WAN. This may include an attempt to directly connect to the WAN. It may also include the broadcast of a discovery signal to reach out for UE relays as discussed in U.S. patent application Ser. Nos. 14/107,195 and 14/107,221.

At block 520, if the first device is not currently able to upload the data to the WAN, the first device may elect to broadcast the data over the D2D resources. Thus, another one of the peer devices may be able to upload the data.

At block 522, if the first device is currently able to upload the cached data to the WAN, the first device may proceed with uploading the data. As discussed herein, the first device may either upload the data directly or upload the data via a relay.

At block 524, the first device monitors for a confirmation from the WAN. For example, in another time slot, the first device may listen to the WAN for broadcasts of delivery confirmations of data messages delivered by the first device and/or its peer devices.

The confirmation message(s) may take various forms. As one example, the network may send a corresponding dedicated message to each device (i.e., one message for the second device and another message for the third device). As another example, the network may send a single message that contains an acknowledgement for the second device and an acknowledgement for the third device. As yet another example, the network may send a group acknowledgement that serves to confirm delivery of the data messages from all of the devices.

At block 526, the first device clears its cache locations for the data in the event the first device receives a confirmation from the WAN indicating that the WAN successfully received the data. For example, when the first device receives a confirmation message, the first device evaluates the message IDs contained in the WAN's confirmation and clears the corresponding messages from the first device's cache, if applicable. Similar operations may be performed at an MTC device that receives an acknowledgment corresponding to data cached by the MTC device.

Different techniques may be used to manage exchanged data in different implementations. For example, devices may determine whether and/or when to delete data from memory (e.g., cache) in an autonomous manner or in a cooperative manner.

In some implementations, each device determines on its own whether and/or when to delete data from its memory (e.g., cache). For example, a device may clear data from a cache whenever the device receives an ACK associated with that data. As another example, a device may unilaterally clear data from a cache if the data has been in the cache for more than a threshold amount of time.

In some implementations, devices may cooperate to determine whether and/or when to delete data from memory (e.g., cache). For example, once a device receives an acknowledgement for a given set of data, that device may send a message to its peers informing the peers that the data has been acknowledged.

In a scenario where cached data was received at a first device from a second device, the first device may clear the data from a cache if other data is subsequently received from the second device. In this case, there may be an understanding that a device will continue to exchange its data (e.g., periodically) as long as that data has not been acknowledged. Thus, the absence of a set of data in a subsequent message sent by a given source device implies that the source device received an acknowledgement for that set of data. In some implementations, the sequencing of such messages may be tracked through the use of sequence numbers for data exchange messages sent by the devices. For example, a given device may increment its sequence number whenever it transmits a message exchanging data.

In the learning procedure mentioned above, peer devices (e.g., devices of a certain device class or a certain set of classes) in an area can monitor transmissions on a designated peer-to-peer resource (e.g., a designated set of time slots and/or frequency bands). In this way, the peer devices can determine what peer devices (and how many peer devices) are in their respective vicinities. Optionally, the peer devices can determine the resources (e.g., the subset of the entire designated resource) that their respective neighbors use. This monitoring may occur during idle mode, during connected mode, or some other operating mode of a device. Also, the learning procedure may be restricted to devices of a certain class or set of classes.

In some aspects, the identification of peer devices involves identifying all of the devices that are within a defined proximity. This may involve, for example, determining a location (e.g., geographical coordinates, associated eNB, etc.) of each device. As another example, the signal strength of signals received from devices of a designated class (or designated classes) may be compared to a threshold to determine whether a given device is proximate (near) another device.

Based on this learned information, devices (e.g., peer devices of a certain class or set of classes) can optionally cooperate to create a schedule for themselves. For example, the schedule may specify how the peer devices will share a resource, how the peer devices are going to exchange data among themselves, how far (e.g., the number of hops) the data will be exchanged, and so on. Criteria for determining such a schedule can depend on various factors including, for example, available resources (e.g., time slots, frequency bands, tones, etc.), traffic requirements of each device, the amount of data queued at each device, relative priorities of the devices, relative classes of the devices, interference between the devices, network interference, and so on.

In some implementations, the schedule is created as a subset of a set of resources designated by a WAN, a nearby eNB, or some other network entity for the schedule. For example, a given set of time slots (with associated timing) may be allocated for D2D scheduling. The devices may then allocate all or a subset of those resources among themselves for D2D communication (e.g., data exchange, transmission of control messages, etc.). Thus, in some aspects, the schedule devised by the devices may be synchronized to a master schedule specified by a WAN, an eNB, etc.

Class of devices can be defined in various ways. For example, a device class may relate to power (e.g., power consumption), cost, transmit power, power source, form factor, battery life, amplifier, bandwidth, or some other suitable characteristic of a device. In some implementations, a degree within a class (e.g., a classification such as “low,” “high,” “narrow,” “wide,” and so on may be defined relative to a threshold. For example, a low power device may be defined as a device that has a power characteristic that is below a defined threshold, while a high power device may be defined as a device that has a power characteristic that is above a defined threshold (e.g., the same threshold or a different threshold).

For a power-based class, devices can be classified relative to one another depending on the power characteristics (e.g., power consumption, available power, etc.) of the device. As one example, a device classified as a low power device is associated with lower power (e.g., consumes less energy over a period of time) than a device classified as a high power device. In different implementations, a different number of power classes (e.g., low power, medium power, high power, and so on) can be defined relative to one another. Classifiers other than low, high, etc., could also be used. For example, a class 1 device could have lower power than a class 2 device.

For a cost-based class, devices can be classified relative to one another depending on the cost of the device. As one example, a device classified as a low cost device is associated with lower cost (e.g., manufacturing cost, sale cost, etc.) than a device classified as a high cost device. In different implementations, a different number of cost classes (e.g., low cost, medium cost, high cost, and so on) can be defined relative to one another. Classifiers other than low, high, etc., could also be used. For example, a class 1 device could have lower cost than a class 2 device.

For a transmit power-based class, devices can be classified relative to one another depending on the transmit power of the device. As one example, a device classified as a low transmit power device is associated with lower transmit power (e.g., lower maximum transmit power, lower average transmit power, lower pilot transmit power, lower traffic transmit power, lower overall transmit power, etc.) than a device classified as a high transmit power device. In different implementations, a different number of transmit power classes (e.g., low transmit power, medium transmit power, high transmit power, and so on) can be defined relative to one another. Classifiers other than low, high, etc., could also be used. For example, a class 1 device could have lower transmit power than a class 2 device.

For a power source-based class, devices can be classified relative to one another depending on the type of power source or power sources employed by the device. As one example, some devices may be classified as a battery powered devices and other devices classified as plug-in (e.g., AC powered) devices. In different implementations, a different number of power source classes (e.g., battery powered, AC powered, multi-power source powered, and so on) can be defined relative to one another. Classifiers other than battery, AC, etc., could also be used. For example, a class 1 device could have a different type of power source than a class 2 device.

For a form factor-based class, devices can be classified relative to one another depending on the form factor of the device. As one example, a device classified as a small form factor device is associated with smaller form factor (e.g., size, shape, etc.) than a device classified as a larger form factor device. In different implementations, a different number of form factor classes (e.g., small form factor, medium form factor, large form factor, and so on) can be defined relative to one another. Classifiers other than small, large, etc., could also be used. For example, a class 1 device could have a smaller form factor than a class 2 device.

For a battery life-based class, devices can be classified relative to one another depending on the battery life of the device. As one example, a device classified as a short battery life device is associated with shorter battery life (e.g., maximum battery life, average battery life, minimum battery life, etc.) than a device classified as a long battery life device. In different implementations, a different number of battery life classes (e.g., short battery life, medium battery life, long battery life, and so on) can be defined relative to one another. Classifiers other than short, long, etc., could also be used. For example, a class 1 device could have a shorter battery life than a class 2 device.

For an amplifier-based class, devices can be classified relative to one another depending on an amplifier employed by the device. As one example, a device classified as a limited power amplifier device is associated with more limited amplification capabilities (e.g., lower maximum amplification, lower average amplification, etc.) than a device classified as a non-limited amplifier device. As another example, a device classified as a limited power amplifier device is associated with more limited range of transmission (e.g., lower maximum range of transmission, lower average range of transmission, etc.) than a device classified as a non-limited power amplifier device. In different implementations, a different number of amplifier (e.g., power amplifier) classes (e.g., low power amplifier, medium power amplifier, high power amplifier, and so on) can be defined relative to one another. Classifiers other than low, high, etc., could also be used. For example, a class 1 device could have lower amplification than a class 2 device.

For a bandwidth-based class, devices can be classified relative to one another depending on the bandwidth (e.g., radio frequency (RF) bandwidth) of the device. As one example, a device classified as a narrow frequency band device is associated with a narrower bandwidth (e.g., transmission and/or reception is done using a narrower RF band) than a device classified as a wide frequency band device. In different implementations, a different number of bandwidth classes (e.g., narrow bandwidth, medium bandwidth, wide bandwidth, and so on) can be defined relative to one another. Classifiers other than narrow, wide, etc., could also be used. For example, a class 1 device could use a narrower frequency band than a class 2 device.

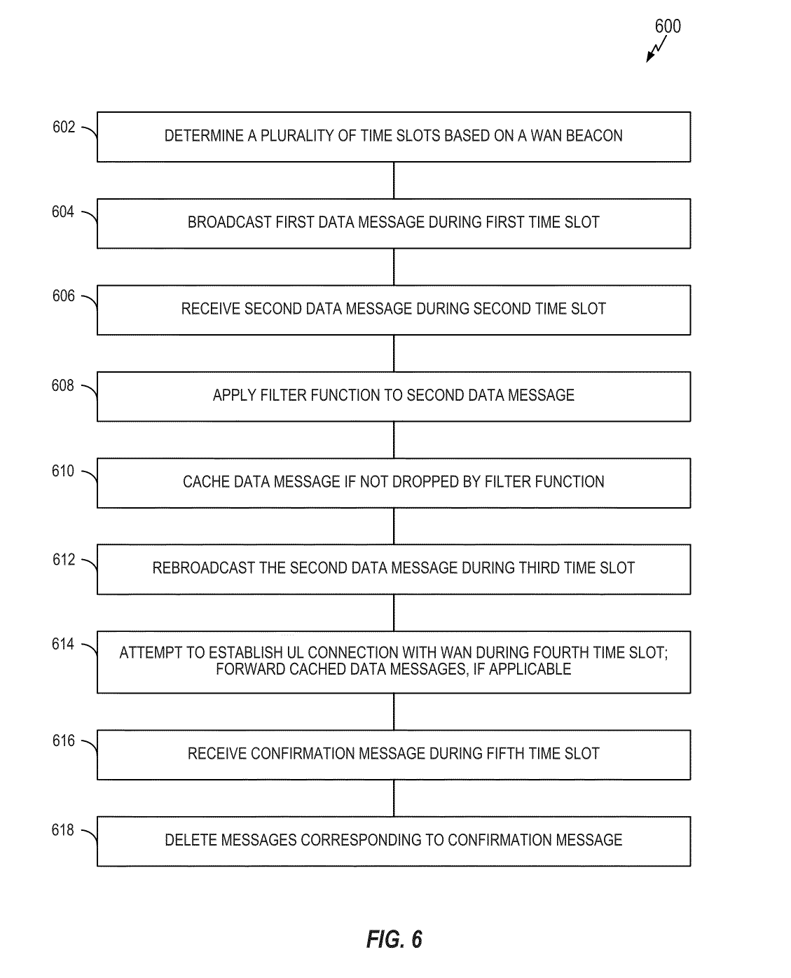

FIG. 6 illustrates a more specific example of a process 600 executed by an MTC device in accordance with some aspects of the disclosure. It should be appreciated that the process 600 may be implemented by any suitable apparatus capable of supporting data exchange-related operations.

At block 602, the MTC device determines a plurality of time slots based on a WAN beacon. For example, the MTC device may identify the timeslots to be used for D2D discovery, paging, traffic, and acknowledgements.

At block 604, the MTC device broadcasts a first data message containing a first identifier. The message is broadcast during a first time slot.

At block 606, the MTC device receives a second data message containing an identifier. This message is received during a second time slot.

At block 608, the MTC device applies a filter function to the second data message.

At block 610, the MTC device caches the data message if the data message is not dropped by the filter function.

At block 612, the MTC device rebroadcasts the data message during a third time slot.

At block 614, the MTC device attempts to establish an UL connection with the WAN in a fourth time slot. If such a connection is established, the MTC device forwards the cached data messages to the WAN.

At block 616, the MTC device receives a confirmation message from an eNB during a fifth time slot. This message contains a set of identifiers.

At block 618, the MTC device compares the identifiers in the confirmation message to the identifiers of the data messages cached. The MTC device then deletes those messages for which a match was found.

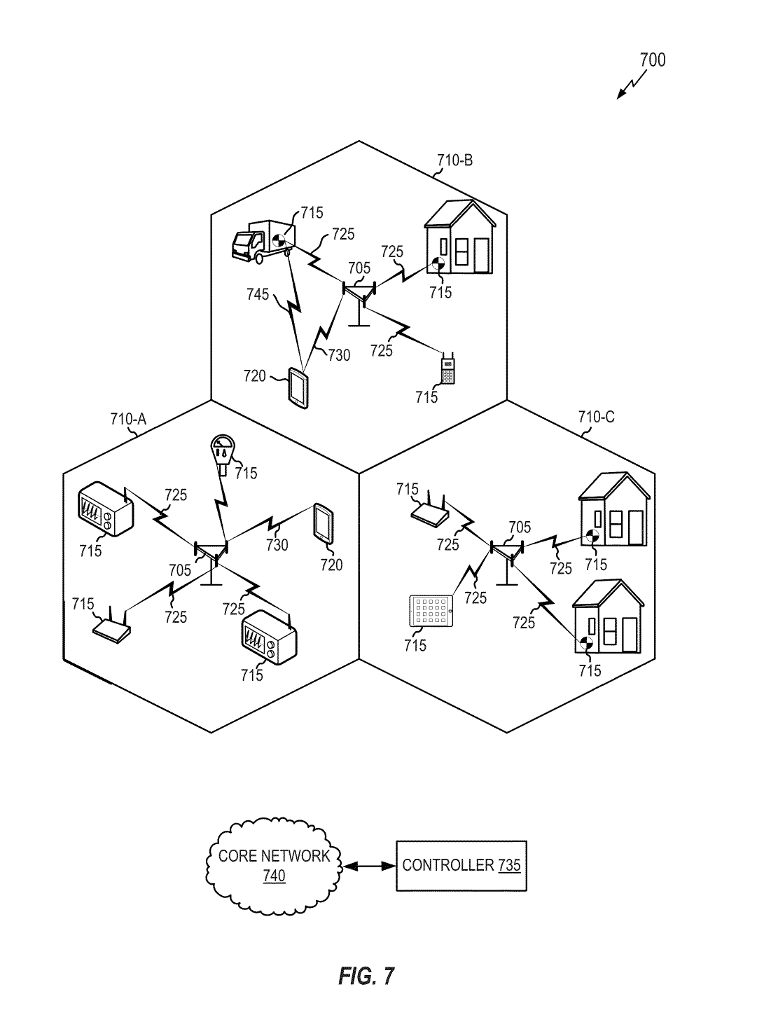

Several example details of the disclosure will now be described with reference to FIGS. 7-14. For purposes of illustration, these figures may illustrate various components in the context of machine-to-machine (M2M) communication, machine type communication (MTC), or LTE technology. For example, the following discussion relates in some aspects to uplink communication of a machine type communication (MTC) device by aggregating and relaying communication through a first device (e.g., a relay device such as a mobile device, a UE, etc.) to a second device (e.g., a base station such as an eNB). It should be appreciated, however, that the teachings herein may be implemented using other types of radio technologies and architectures. Also, various operations may be described as being performed by specific types of components (e.g., M2M devices, MTC devices, sensors, base stations, client devices, peer-to-peer devices, user equipment (UE), and so on). It should be understood that these operations can be performed by other types of devices. To reduce the complexity of these figures, only a few example components are shown. However, the teachings herein can be implemented using a different number of components or other types of components.

FIG. 7 illustrates an example of a wireless communication system (e.g., network) 700. The system 700 includes base stations 705, communication devices 715, 720, a base station controller 735, and a core network 740 (the base station controller 735 may be integrated into the core network 740). The system 700 may support operation on multiple carriers (waveform signals of different frequencies). Multi-carrier transmitters can transmit modulated signals simultaneously on the multiple carriers. For example, each modulated signal may be a multi-carrier channel modulated according to the various radio technologies described herein. Each modulated signal may be sent on a different carrier and may carry control information (e.g., pilot signals, control channels, etc.), overhead information, data, etc. The system 700 may be a multi-carrier LTE network capable of efficiently allocating network resources.

The base stations 705 may wirelessly communicate with the devices 715, 720 via a base station antenna (not shown). The base stations 705 may communicate with the devices 715, 720 under the control of the base station controller 735 via multiple carriers. Each of the base station 705 sites may provide communication coverage for a respective geographic area or cell. In some embodiments, the base stations 705 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area (or cell) for each base station 705 here is identified as 710-A, 710-B, or 710-C. The coverage area for a base station may be divided into sectors (not shown, but making up only a portion of the coverage area). The system 700 may include base stations 705 of different types (e.g., macro, pico, and/or femto base stations). A macro base station may provide communication coverage for a relatively large geographic area (e.g., 35 km in radius). A pico base station may provide coverage for a relatively small geographic area (e.g., 12 km in radius), and a femto base station may provide communication coverage for a relatively smaller geographic area (e.g., 50 m in radius). There may be overlapping coverage areas for different technologies.

The devices 715, 720 may be dispersed throughout the coverage areas 710. Each device 715, 720 may be stationary or mobile. In one configuration, the devices 715, 720 may be able to communicate with different types of base stations such as, but not limited to, macro base stations, pico base stations, and femto base stations, via links 725, 730, and 745.

Some of the devices 715 may be machine type communication (MTC) devices 715 that perform various functions, capture information, and/or communicate information with limited or no human intervention. For example, MTC devices 715 may include sensors and/or meters for monitoring and/or tracking other devices, environmental conditions, etc. MTC devices 715 may be standalone devices or, in some embodiments, MTC devices 715 may be modules incorporated in other devices. These other devices may include the devices 720, such as relay devices 720, which may in some cases be mobile devices or user equipments (UEs). For example, relay devices 720 such as smart phones, cellular phones and wireless communication devices, personal digital assistants (PDAs), tablets, other handheld devices, netbooks, ultrabooks, smartbooks, notebook computers, surveillance cameras, handled medical scanning devices, home appliances, etc., may include one or more MTC device modules. In other cases, relay devices 720 might not implement any MTC functionality.

In the ensuing description, various techniques are described as applied to communication and processing for the system 700 including a network and one or more MTC devices 715. It should be understood that the described techniques may be advantageously applied to other devices such as those incorporating MTC devices 715 and/or other wireless communication devices.

In some implementations, an MTC device 715 may communicate with a base station 705 by relaying information through a relay device 720. In some cases, the MTC device 715 may relay uplink data to a base station 705 through the link 745 to a relay device 720, and the relay device 720 may cache and then forward the MTC data to the base station 705 via the link 730 (e.g., via a WAN uplink channel). The base station 705 may communicate on the downlink directly with the MTC device 715 via the link 725.

In various embodiments, the relay device 720 may communicate with the MTC device 715 directly or indirectly. For example, the relay device 720 may communicate with the MTC device 715 directly via the link 745 (e.g., uplink and downlink). In addition, the relay device 720 may communicate, e.g., transmit messages, to the MTC device 715 by routing messages through a base station 705, such as via the links 730 and 725 (e.g., downlink).

The information collected by the MTC devices 715 may be transmitted across a network that includes components of the system 700 to a back-end system, such as a server. The transmission of data to/from the MTC devices 715 may be routed through the base stations 705. The base stations 705 may communicate with the MTC devices 715 on a forward or downlink link for transmitting signaling and/or information to the MTC devices 715 and a reverse or uplink link for receiving signaling and/or information from the MTC devices 715.

In one example, the base station controller 735 may be coupled to a set of base stations 705 and provide coordination and control for these base stations 705. The base station controller 735 may communicate with the base stations 705 via a backhaul (e.g., core network 740). The base stations 705 may also communicate with one another directly or indirectly and/or via wireless or wireline backhaul.

The different aspects of the system 700, such as the MTC devices 715, the relay devices 720, the base stations 705, the core network 740, and/or the base station controller 735 may be configured for improving uplink communication of an MTC device 715. In one configuration, a relay device 720 may cache and relay communication received from the MTC devices 715 to a second device, such as a base station 705. The communication may be transmitted from the MTC devices 715 to the relay device 720 via the links 745 (e.g., a narrow frequency band link). The relay device 720 may relay the communication to the base station 705 via a link 730 (e.g., a broad frequency band link).

From the perspective of a relay device 720, the relay device 720 may participate in a discovery process to discover an MTC device 715. This may occur, for example, if the relay device 720 detects an MTC device 715 that has data to transmit, and/or if a base station 705 has data to communicate with the MTC device 715.

In some cases, the relay device 720 may initiate the discovery process by broadcasting a peer discovery signal to indicate availability to serve as a relay. The relay device 720 may then receive a request to serve as a relay from an MTC device 715. The relay device 720 may transmit a message to the MTC device 715 confirming that it will serve as a relay.

In other cases, the MTC device 715 may initiate the discovery process such that the relay device 720 may receive a peer discovery signal from the MTC device 715. The relay device 720 may then transmit a message indicating availability to serve as a relay to the MTC device 715. The relay device 720 may subsequently receive a request from the MTC device 715 to serve as a relay.

Once the relay relationship has been confirmed between the relay device 720 and the MTC device 715, the relay device 720 may then receive data from the discovered MTC device, such as through the link 745 (e.g., a peer-to-peer (P2P) link). The relay device 720 may thus cache the received data along with other cached received data, and relay the aggregated data to a base station through a second communication link 730, which may be a Long Term Evolution (LTE) link.

From the perspective of an MTC device 715, the MTC device 715 may participate in a discovery process with a first device 720, such as a mobile station or UE. This may occur, for example, if the MTC device 715 has data to communicate with a base station 705.

In some cases, the MTC device 715 may initiate the discovery process by broadcasting a peer discovery signal to request that a device serve as a relay for MTC communication. The MTC device 715 may receive a message from a device 720 that received the peer discovery signal. The message may indicate that the device 720 is available to serve as a relay device.

In other cases, the device 720 may initiate the discovery process. In this case, the MTC device 715 may receive a peer discovery signal from the device 720, with the peer discovery signal indicating that the device 720 is available to serve as a relay device. In response, the MTC device 715 may transmit a message confirming that the MTC device 715 has data to relay to a base station 705, for instance, through the relay device 720.

After the MTC device 715 and the relay device 720 have discovered each other, the MTC device 715 may transmit data to the relay device 720 for caching and subsequent relaying to a base station 705 with other aggregated data. In some cases, the MTC device 715 may establish a peer-to-peer (P2P) connection via a link 745 with the relay device 720 and transmit data to be relayed to the relay device 720 over the link 745 (e.g., P2P connection).

In some embodiments, uplink communication from the MTC device 715 to the base station 705 may be relayed through the relay device 720 via the links 745 and 730, while downlink communication may be communicated directly from the base station 705 to the MTC device 715 via the link 725. In this way, uplink communication budgets of the MTC devices 715 can be improved without modification to the MTC devices 715 themselves and with reduced impact to the system 700.

The relay device 720 may communicate routing information or other information to a base station 705 to enable downlink communication between the base station 705 and the MTC device 715. In various embodiments, downlink communication may be communicated directly from the base station 705 to the MTC device 715, or indirectly from the base station 705 to the MTC device 715 via the relay device 720.

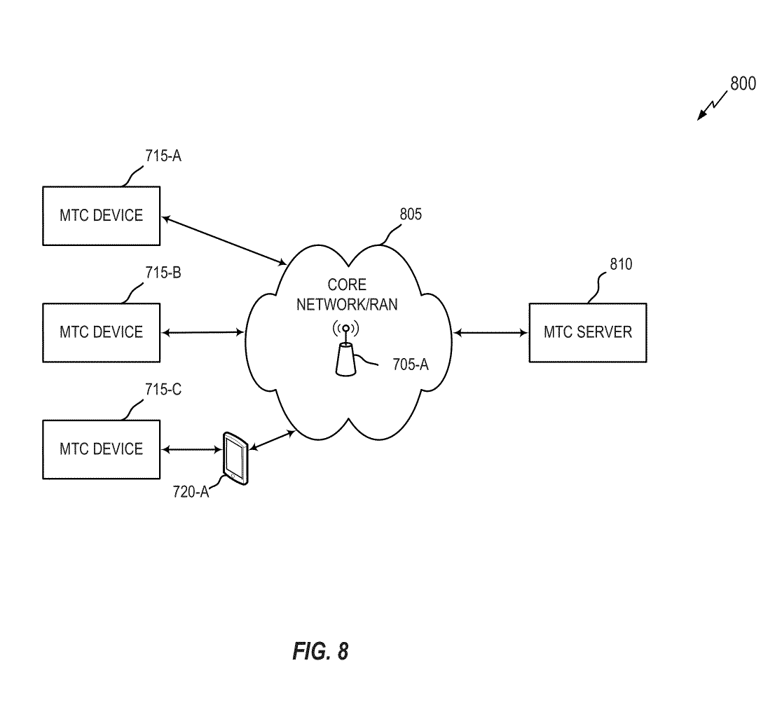

FIG. 8 illustrates an example of a wireless communication system 800 including a Radio Access Network (RAN) or Core Network 805 implementing a machine type communication service according to one aspect. The system 800 may include any number of MTC devices 715, however for ease of explanation only three MTC devices 715-A, 715-B, and 715-C are shown in communication with an MTC server 810. Communication between the MTC server 810 and the MTC devices 715-A, 715-B, and 715-C may be routed through a base station 705-A that may be considered part of the Core Network/RAN 805. The base station 705-A may be an example of the base stations 705 illustrated in FIG. 7. The MTC devices 715-A, 715-B, and 715-C may be examples of the MTC devices 715 illustrated in FIG. 7, or may be examples of modules of the relay devices 720 illustrated in FIG. 7. One skilled in the art would understand that the quantity of the MTC devices 715, the Core Networks/RANs 805, and the MTC servers 810 shown in FIG. 8 is for illustration purposes only and should not be construed as limiting.

The wireless communication system 800 may be operable to facilitate machine type communication between one or more MTC devices 715 and/or one or more base stations 705-A. Machine type communication may include communication between one or more devices without human intervention. In one example, machine type communication may include the automated exchange of data between a remote machine, such as an MTC device 715-A, 715-B, 715-C, and a back-end IT infrastructure, such as the MTC server 810, without user intervention. The transfer of data from an MTC device 715-A, 715-B, 715-C to the MTC server 810 via the Core Network/RAN 805 (e.g., the base station 705-A) may be performed using reverse or uplink link communication. Data collected by the MTC devices 715-A, 715-B, 715-C (e.g., monitoring data, sensor data, meter data, etc.) may be aggregated and then transferred to the MTC server 810 on the uplink communication.

The transfer of data from the MTC server 810 to an MTC device 715-A via the base station 705-A may be performed via forward or downlink link communication. The forward link may be used to send instructions, software/firmware updates, and/or messages to the MTC devices 715-A, 715-B, 715-C. The instructions may instruct the MTC devices 715-A, 715-B, 715-C to remotely monitor equipment, environmental conditions, etc. Machine type communication may be used with various applications such as, but not limited to, remote monitoring, measurement and condition recording, fleet management and asset tracking, infield data collection, distribution, physical access control, and/or storage, etc. The base station 705-A may generate one or more forward link frames with a small number of channels to transmit instructions, software/firmware updates, and/or messages. The various MTC devices 715-A, 715-B, 715-C may wake up to monitor a specific frame when instructions or other data is included on a channel of that frame.

In one embodiment, the behavior of the MTC devices 715-A, 715-B, 715-C may be pre-defined. For example, the day, time, etc., to monitor another device and transmit the collected information may be pre-defined for an MTC device 715-A, 715-B, 715-C. For example, the MTC device 715-A may be programmed to begin monitoring another device and collect information about that other device at a first pre-defined time period. The MTC device 715-A may also be programmed to transmit the collected information at a second predefined time period. The behavior of an MTC device 715-A may be remotely programmed to the MTC device 715-A.

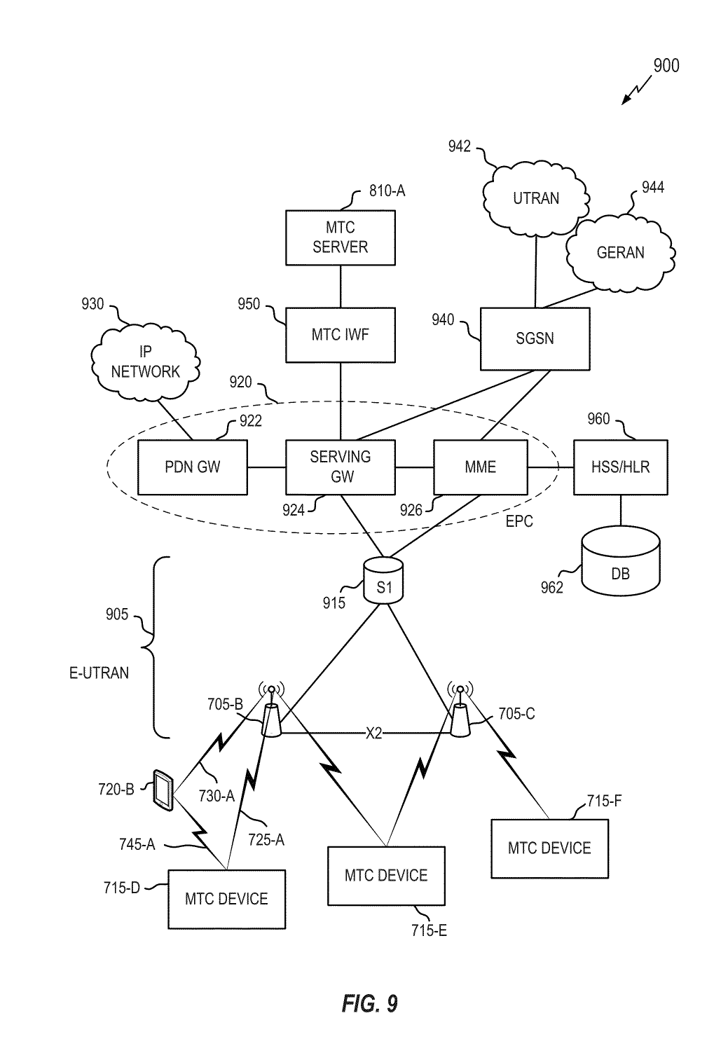

In some embodiments, one or more MTC devices 715-A, 715-B, 715-C may have data to send to the MTC server 810, for example through the core network/RAN 805 via base station 705-A. In other cases, the MTC server 810 may request data from the one or more MTC devices 715-A, 715-B, 715-C. In either case, an MTC device 715-A, 715-B, 715-C may have uplink data to communicate to a base station 705-A to be relayed to the MTC server 810. Given that MTC devices 715-A, 715-B, 715-C may be narrow frequency band devices and/or may have limited power resources, they might not be able to effectively and timely communicate data on the uplink to a base station 705-A and/or the MTC server 810. Communication, and particularly uplink communication of an MTC device, for example the MTC device 715-C, may be improved by relaying data communication to a base station 705 and/or the MTC server 810 through a relay device 720-A. These relay techniques will be described in further detail below in reference to FIGS. 9-14.

FIG. 9 illustrates an example of a wireless communication system 900 implementing a machine type communication service over an LTE/LTE-Advanced network in accordance with various embodiments. The LTE/LTE-A network may include an Evolved Universal Terrestrial Radio Access Network (E-UTRAN) 905 and an Evolved Packet Core (EPC) 920. The LTE E-UTRAN 905 and the EPC 920 may be configured for supporting end-to-end packet-switched communication. The EPC 920 may include a Packet Data Network (PDN) Gateway 922. The PDN Gateway 922 may be connected to one or more Internet Protocol (IP) Networks 930. IP Networks 930 may include Operator IP Networks as well as external IP Networks. For example, IP Networks 930 may include the Internet, one or more Intranets, an IP Multimedia Subsystem (IMS), and a Packet Switched (PS) Streaming Service (PSS). The PDN Gateway 922 may provide UE IP address allocation as well as other functions. The EPC 920 may interconnect with other access networks using other Radio Access Technologies (RATs). For example, the EPC 920 may interconnect with the UTRAN 942 and/or the GERAN 944 via one or more Serving GPRS Support Nodes (SGSNs) 940.

The EPC 920 may include one or more Serving Gateways 924 and/or Mobility Management Entities (MME) 926. The Serving Gateway 924 may handle the interface to the E-UTRAN 905 and provide a communication point for inter-RAT mobility (e.g., handover to the UTRAN 942 and/or the GERAN 944, etc.). Generally, the MME 926 may provide bearer and connection management while the Serving Gateway 924 may transfer user IP packets between base stations 705 and other network end-points (e.g., the PDN GW 922, etc.). For example, the MME 926 may manage intra-RAT mobility functions (e.g., Serving Gateway selection) and/or UE tracking management. The Serving Gateway 924 and the MME 926 may be implemented in one physical node of the EPC 920 or in separate physical nodes. A Home Subscriber Service (HSS) and/or home location register (HLR) node 960 may provide service authorization and/or user authentication for UEs. The HSS/HLR node 960 may communicate with one or more databases 962.

The E-UTRAN 905 may include one or more base stations (e.g., eNBs) 705-B, 705-C which provide user and control plane protocol terminations for the MTC devices 715-D, 715-E, 715-F, and/or a relay device or UE device 720-B over the air interface of the LTE network. The eNBs 705-B, 705-C may be connected with an X2 interface for intra-eNB communication. The base station 705-B, 705-C may be connected to the Serving Gateway 924 and/or the MME 926 over an S-1 interface 915 for communicating data traffic and/or control plane information. The MTC devices 715-D, 715-E, 715-F, and/or the relay device 720-B may be configured to collaboratively communicate with multiple base stations 705 through, for example, Multiple Input Multiple Output (MIMO), Coordinated Multi-Point (CoMP), or other schemes as described in more detail below.

In some embodiments, the wireless communication system 900 includes an MTC inter-working function (IWF) module 950, which may provide an interface between the EPC 920 and one or more external MTC Servers 810-A for providing MTC service within the LTE network. The MTC server 810-A may be an example of the MTC server 810 of FIG. 8. The MTC server 810-A may be operated by the proprietor of the MTC devices 715 and may perform functions associated with deployment of the MTC devices 715 such as receiving and processing MTC device data. The MTC server 810-A may be connected directly to the EPC 920 or may be connected through the MTC IWF module 950 and/or other networks such as the Internet. The MTC IWF module 950 may be implemented in one or more existing physical nodes of the EPC 920 (e.g., the Serving Gateway 924, etc.), or in a separate physical node connected to the EPC 920.

The wireless communication system 900 may further support relay of communication from an MTC device 715-D to a base station 705-B through a relay device 720-B. For example, the relay device 720-B may participate in a discovery process with an MTC device 715-D. After the relay device 720-B and the MTC device 715-D have discovered each other, the relay device 720-B may receive data from the discovered MTC device 715-D over the link 745-A, which may be a P2P link, implementing LTE-D, Wi-Fi-Direct, or other P2P technology, for example. The relay device 720-B may then aggregate this data along with data received from other MTC devices and then forward (relay) the aggregated MTC data to the base station 705-B over the link 730-A, which may implement LTE, or other WLAN technology. In other embodiments, the MTC device 715-D may participate in a discovery process with the relay device 720-B. Once discovery is complete, the MTC device 715-D may transmit data to the relay device 720-B via the link 745-A to be aggregated and then relayed to the base station 705-B via the link 730-A. In some embodiments, the relay device 720-B may communicate, e.g., transmit messages to the MTC device 715-D, through the base station 705-B, such as through the links 730-A and 725-A.

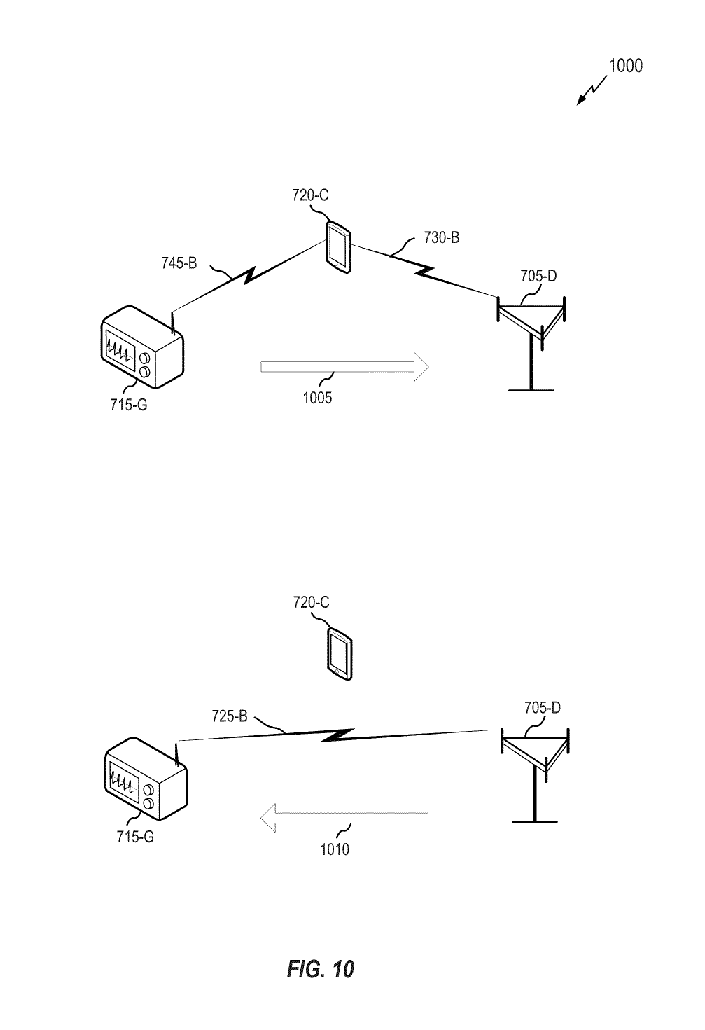

FIG. 10 illustrates an example of wireless communication 1000 between an MTC device 715-G, a relay device 720-C, and a base station 705-D in accordance with various embodiments. The MTC device 715-G may be an example of the MTC device 715 of FIGS. 7, 8, and/or 9. The relay device 720-C may be an example of the relay device or UE 720 of FIGS. 7, 8, and/or 9. The base station 705-D, which may be a cellular base station, an eNB, a WLAN access point, etc., may be an example of the base station 705 of FIGS. 7, 8, and/or 9. The MTC device 715-G may communicate with the base station 705-D on the uplink 1005 and on the downlink 1010.

In some embodiments, the MTC device 715-G may communicate on the uplink 1005 with the base station 705-D through relaying communication through a relay device 720-C. The MTC device 715-G and the relay device 720-C may participate in a discovery process. Once discovery is complete, the relay device 720-C may receive data from the discovered MTC device 715-G via the link 745-B, which may be a LTE-D link, to be aggregated and relayed to the base station 705-D. After receiving the MTC data from the MTC device 715-G and aggregating this data with other received data, the relay device 720-C may then forward the aggregated MTC data to the base station 705-D via the link 730-B, which may be an LTE link.

From the perspective of the MTC device 715-G, the process for relaying data through the relay device 720-C to the base station 705-D may be described as follows. The MTC device 715-G and the relay device 720-C may participate in a discovery process. Once discovery is complete, the MTC device may transmit data to be relayed to the base station 705-D which in turn may be relayed to an MTC server, such as the MTC server 810 as described above in reference to FIGS. 8 and/or 9. The MTC device 715-G may transmit the data first to the relay device 720-C via the link 745-B, which may be a P2P link, such as an LTE-D link or other type of WLAN link, such as a WiFi-Direct link, to be relayed to the base station 705-D. The relay device 720-C may then aggregate and forward the MTC data to the base station 705-D via the link 730-B, which may be an LTE or other WLAN link.

In some embodiments, the base station 705-D may communicate on the downlink 1010 directly with the MTC device 715-G, such as over the link 725-B. In some cases, the link 725-B may be an LTE link, as described above, or may implement another radio access technology, such as WLAN, 3G, 4G, 5G, etc. In some cases, by allowing direct downlink communication 1010 between the MTC device 715-G and the base station 705-D, the impact on the network, such as the system 700, may be reduced. Impact on the network may be reduced by, for example, utilizing less resources of a relay device 720-C.

It should be appreciated that in some cases, it may be beneficial for the MTC device 715-G, the relay device 720-C, and/or the base station 705-D for downlink communication between the base station 705-D and the MTC device 715-G to also be relayed through the relay device 720-C.

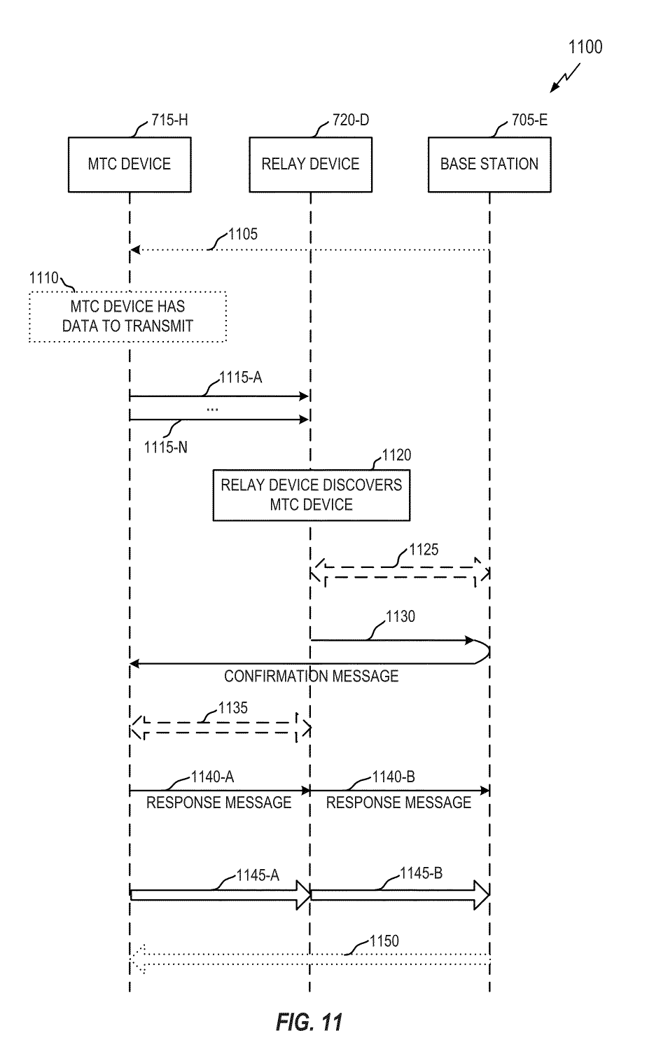

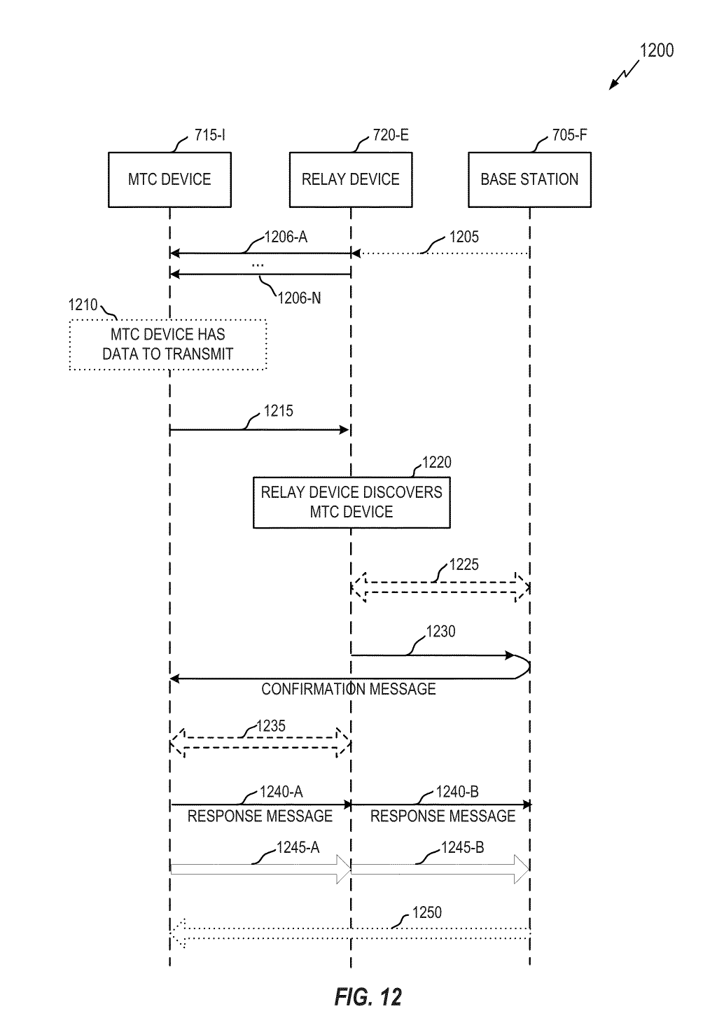

Turning next to FIGS. 11 and 12, flow diagrams 1100 and 1200 illustrate a scenario where a relay device sets up a connection between an MTC device and a base station for relaying communication through the relay device in accordance with various embodiments.

In FIG. 11, a flow diagram 1100 illustrates an example of an MTC device 715-H relaying communication to a base station 705-E through a relay device 720-D in accordance with various embodiments. The MTC device 715-H may be an example of the MTC device 715 of FIGS. 7, 8, 9, and/or 10. The relay device 720-D may be an example of the relay device or the UE device 720 of FIGS. 7, 8, 9, and/or 10. The base station 705-E, which may be a cellular base station, an eNB, or a WLAN access point, may be an example of the base station 705 of FIGS. 7, 8, 9, and/or 10.

In some embodiments, an MTC server 810 may, through the base station 705-E, transmit one or more messages 1105 to the MTC device 715-H, for example, to request that the MTC device 715-H send data to the MTC server 810 through the base station 705-E. The data, for instance, may include sensor or related data. In other cases, the MTC server 810 through the base station 705-E, may notify the MTC device 715-H that it has software updates, revised scheduling of MTC reporting, or other operation information to convey to the MTC device 715-H. The base station 705-E may transmit one or more messages 1105 to the MTC device 715-H indicating a need, by the base station 705-E and/or the MTC server 810, to communicate with the MTC device 715-H. The MTC device 715-H may then transmit or broadcast one or more discovery signals 1115-A to 1115-N, such as one or more peer discovery signals, to establish a relay link with a relay device 720-D.

In other cases, the MTC device 715-H may have data to transmit 1110 to an MTC server 810, such as through a base station 705-E. In some cases, the MTC device 715-H may have data to transmit 1110 and may be messaged by the base station 705-E concurrently.

In any of the above cases, the MTC device 715-H may broadcast a discovery signal 1115-A to 1115-N until discovered by a relay device 720-D. The relay device 720-D may then discover 1120 the MTC device 715-H. In some cases, if the MTC device 715-H is not discovered within a certain time period, for example 100 seconds, the MTC device 715-H may stop broadcasting a discovery signal 1115, and may broadcast a discovery signal 1115 at another time. After the relay device 720-D discovers 1120 the MTC device 715-H, the relay device 720-D may establish a link 1125, such as an LTE link, with the base station 705-E. Once the link 1125 is established, the relay device 720-D may then confirm that it will act as a relay for the MTC device 715-H by routing a confirmation message 1130 to the MTC device 715-H through the base station 705-E to the MTC device 715-H, such as via links 730 and 725 described above in reference to FIGS. 7 and/or 9. In this way, the MTC device 715-H may receive the confirmation message 1130 from the base station 705-E, as it may be configured to receive other messages from the base station 705-E. This may also give control to the base station 705-E over communication with the MTC device 715-H. As another example, the relay device 720-D may communicate a confirmation message directly with the MTC device 715-H, for example through the link 745 as described above in reference to FIGS. 7, 9, and/or 10.

In some cases, the relay device 720-D may be pre-set to serve as a relay, or a user of the relay device 720-D may confirm availability to serve as a relay, such as via an interface of the relay device 720-D.

The MTC device 715-H and the relay device 720-C may then establish a link 1135 between them. In some cases, the link 1135 may be referred to as an access link, whereas the link 1125 may be referred to as a relay link. The MTC device 715-H may then respond 1140 to the base stations 705-E's initial message 1105, by first sending a response message 1140-A to the relay device 720-D, where the relay device 720-D may then forward the response message 1140-B to the base station 705-E. After the relay relationship has been confirmed and established, such as through the access link 1135, the MTC device 715-H may then send uplink communication 1145-A to the base station 705-E through the relay device 720-D. Here, the relay device 720-D forwards the MTC data 1145-B to the base station 705-E via the relay link 1125. In some embodiments, the access link 1135 and the relay link 1125 may be examples of the links 745 and 730 as described above in reference to FIGS. 7, 9, and/or 10.

Furthermore, transmission of response message 1140-A and communication 1145-A from the MTC device 715-H to the relay device 720-D may be accomplished over link 745 as described above in reference to FIGS. 7, 9, and/or 10. Similarly, transmission of response message 1140-B and MTC data 1145-B from the relay device 720-D to the base station 705-E may be accomplished over link 730 as also described above in reference to FIGS. 7, 9, and/or 10.

In some embodiments, such as where the base station 705-E, with instructions from an MTC server 810, messages 1105 the MTC device 715-H, the base station 705-E may then transmit information 1150 (e.g., updates or other operation information) directly to the MTC device 715-H. In some cases, the base station 705-E may transmit other information 1150 (e.g., messages or data) directly to the MTC device 715-H.

In FIG. 12, a flow diagram 1200 illustrates an example of an MTC device 715-I relaying communication to a base station 705-F through a relay device 720-E in accordance with various embodiments. The MTC device 715-I may be an example of the MTC device 715 of FIGS. 7, 8, 9, 10, and/or 11. The relay device 720-E may be an example of the relay device or the UE device 720 of FIGS. 7, 8, 9, 10, and/or 11. The base station 705-F, which may be a cellular base station, eNB, or WLAN access point, may be an example of the base station 705 of FIGS. 7, 8, 9, 10, and/or 11.

In some embodiments, a relay device 720-E that is configured to act as a relay for MTC communication, may broadcast one or more discovery signals 1206-A to 1206-N, such as one or more peer discovery signals, to the MTC device 715-I. This may be done by the relay device 720-E periodically or when, for instance, the relay device 720-E detects that an MTC device 715-I is nearby. In other cases, an MTC server 810 may, through the base station 705-F transmit one or more messages 1205 to the relay device 720-E to then forward to the MTC device 715-I. After receiving the message 1205 from the base station 705-F, the relay device 720-E may transmit one or more discovery signals 1206-A to 1206-N to the MTC device 715-I to establish a connection to communicate the information from the base station 705-F to the MTC device 715-I.

In some embodiments, the MTC device 715-I may have data to transmit 1210 prior to, concurrently, or shortly after receipt of the discovery signal(s) 1206 sent from the relay device 720-E. In other cases, the MTC device 715-I might not have data to transmit when or proximate in time to when it receives the discovery signal 1206 from the relay device 720-E. In either case, the MTC device 715-I may then decide to respond 1215 to the discovery request sent by the relay device 720-E to confirm establishment of a link between the MTC device 715-I and the relay device 720-E.

The relay device 720-E may thus discover 1220 the MTC device 715-I, confirm 1230 that it will act as a relay for MTC device 715-I by routing a confirmation message 1230 through the base station 705-F to the MTC device 715-I, and establishing a link 1235 with the MTC device 715-I, as similarly described above in reference to FIG. 11. The MTC device 715-I may then confirm with the base station 705-F that the relay link with the relay device 720-E has been established by sending a response message 1240 and then communicate uplink data 1245 to the base station 705-F, as similarly described in reference to FIG. 11. Sending the response message 1240 to the base station 705-F may include first sending the message 1240-A to the relay device 720-E, with the relay device 720-E then forwarding the message 1240-B to the base station 705-F. Similarly, the uplink data may first be communicated 1245-A to the relay device 720-E and then communicated 1245-B by the relay device 720-E to the base station 705-F. Additionally, the base station 705-F may communicate on the downlink 1250 directly with the MTC device 715-I. In some cases, the link 1225 established by the relay device 720-E with the base station 705-F may be an example of the link 730 as described above in reference to FIGS. 7, 9, and/or 10. Establishment of the link 1235 between the MTC device 715-I and the relay device 720-E may be an example of the link 745 as also described in reference to FIGS. 7, 9, and/or 10. Routing a confirmation message 1230 by the relay device 720-E through the base station 705-F to the MTC device 715-I may be accomplished via the links 730 and 725 described above in reference to FIGS. 7 and/or 9, in cases where the link 1225 has been established at this time.

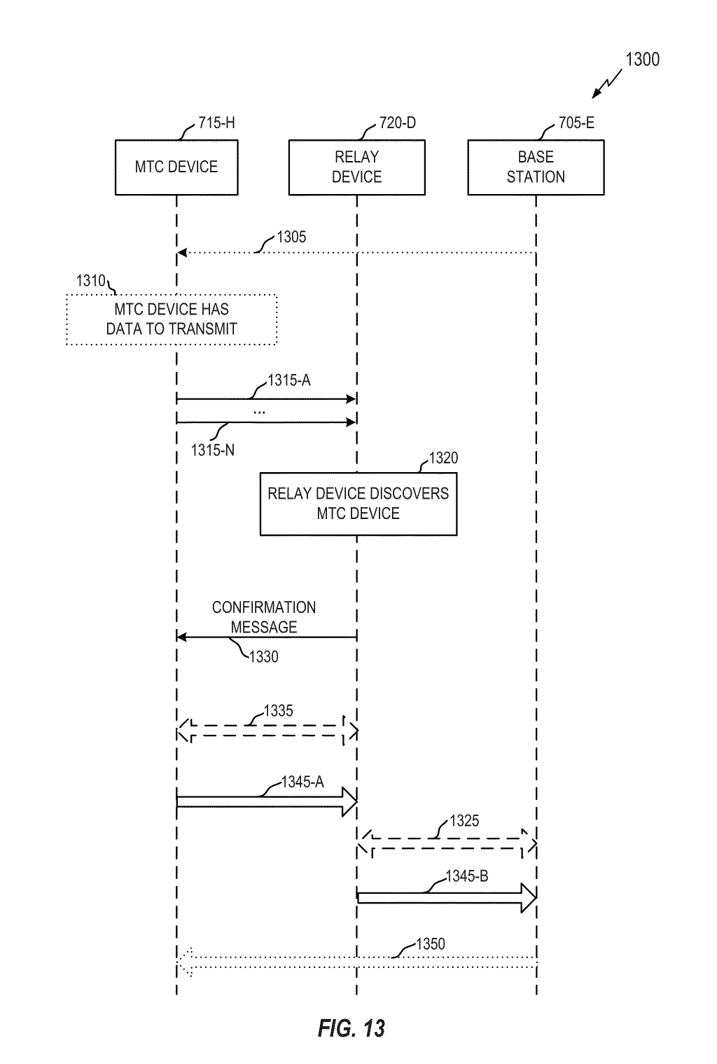

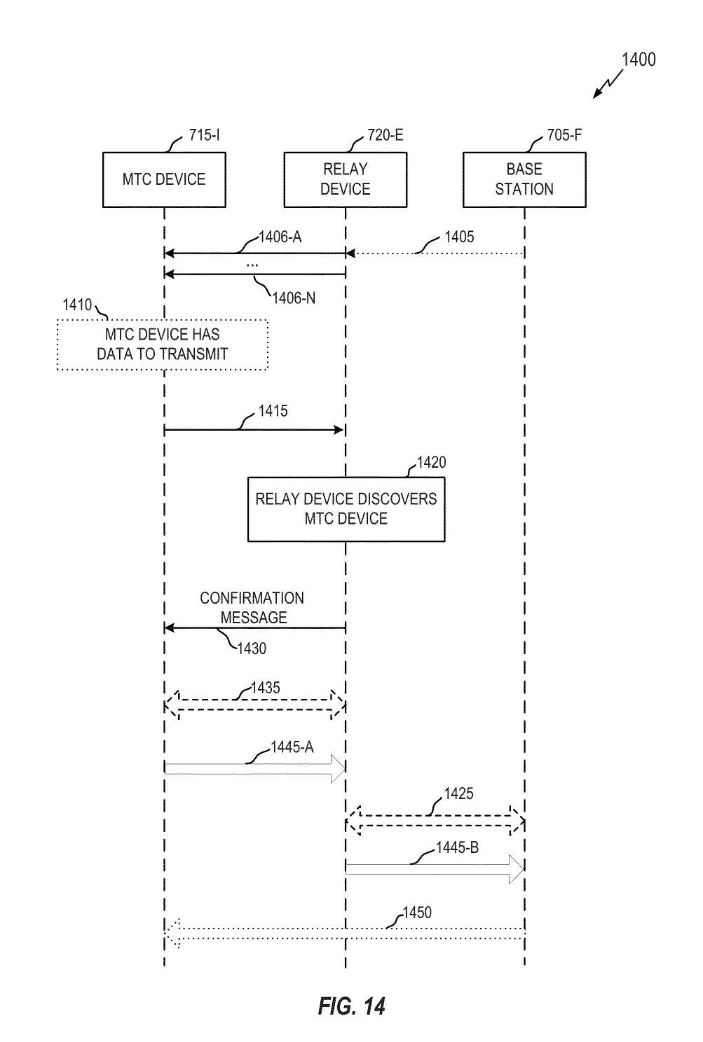

Turning next to FIGS. 13 and 14, flow diagrams 1300 and 1400 illustrate a scenario where a relay device caches and aggregates data received from MTC devices and forwards (relays) the aggregated data to a base station in accordance with various embodiments.

In FIG. 13, a flow diagram 1300 illustrates an example of an MTC device 715-H relaying communication to a base station 705-E through a relay device 720-D in accordance with various embodiments. The MTC device 715-H may be an example of the MTC device 715 of FIGS. 7, 8, 9, and/or 10. The relay device 720-D may be an example of the relay device or the UE device 720 of FIGS. 7, 8, 9, and/or 10. The base station 705-E, which may be a cellular base station, an eNB, or a WLAN access point, may be an example of the base station 705 of FIGS. 7, 8, 9, and/or 10.

In some embodiments, an MTC server 810 may, through the base station 705-E, transmit one or more messages 1305 to the MTC device 715-H, for example, to request that the MTC device 715-H send data to the MTC server 810 through the base station 705-E. The data, for instance, may include sensor or related data. In other cases, the MTC server 810 through the base station 705-E, may notify the MTC device 715-H that it has software updates, revised scheduling of MTC reporting, or other operation information to convey to the MTC device 715-H. The base station 705-E may transmit one or more messages 1305 to the MTC device 715-H indicating a need, by the base station 705-E and/or the MTC server 810, to communicate with the MTC device 715-H. The MTC device 715-H may then transmit or broadcast one or more discovery signals 1315-A to 1315-N, such as one or more peer discovery signals, to establish a relay link with a relay device 720-D.

In other cases, the MTC device 715-H may have data to transmit 1310 to an MTC server 810, such as through a base station 705-E. In some cases, the MTC device 715-H may have data to transmit 1310 and may be messaged by the base station 705-E concurrently.

In any of the above cases, the MTC device 715-H may broadcast a discovery signal 1315-A to 1315-N until discovered by a relay device 720-D. The relay device 720-D may then discover 1320 the MTC device 715-H. In some cases, if the MTC device 715-H is not discovered within a certain time period, for example 100 seconds, the MTC device 715-H may stop broadcasting a discovery signal 1315, and may broadcast a discovery signal 1315 at another time. After the relay device 720-D discovers 1320 the MTC device 715-H, the relay device 720-D may then confirm that it will act as a relay for the MTC device 715-H by routing a confirmation message 1330 to the MTC device 715-H. The relay device 720-D may communicate a confirmation message directly with the MTC device 715-H, for example through the link 745 as described above in reference to FIGS. 7, 9, and/or 10.

In some cases, the relay device 720-D may be pre-set to serve as a relay, or a user of the relay device 720-D may confirm availability to serve as a relay, such as via an interface of the relay device 720-D.

The MTC device 715-H and the relay device 720-C may then establish a link 1335 between them. In some cases, the link 1335 may be referred to as an access link. After the relay relationship has been confirmed and established, such as through the access link 1335, the MTC device 715-H may then send uplink communication 1345-A to the relay device 720-D. The relay device 720-D caches the data, aggregates the data with other received data, establishes a relay link 1325 with the base station 705-E, and then forwards the MTC data 1345-B to the base station 705-E via the relay link 1325. In some embodiments, the access link 1335 and the relay link 1325 may be examples of the links 745 and 730 as described above in reference to FIGS. 7, 9, and/or 10.

In some embodiments, such as where the base station 705-E, with instructions from an MTC server 810, messages 1305 the MTC device 715-H, the base station 705-E may then transmit information 1350 (e.g., updates or other operation information) directly to the MTC device 715-H. In some cases, the base station 705-E may transmit other information 1350 (e.g., other messages or data) directly to the MTC device 715-H.

In FIG. 14, a flow diagram 1400 illustrates an example of an MTC device 715-I relaying communication to a base station 705-F through a relay device 720-E in accordance with various embodiments. The MTC device 715-I may be an example of the MTC device 715 of FIGS. 7, 8, 9, 10, and/or 13. The relay device 720-E may be an example of the relay device or the UE device 720 of FIGS. 7, 8, 9, 10, and/or 13. The base station 705-F, which may be a cellular base station, eNB, or WLAN access point, may be an example of the base station 705 of FIGS. 7, 8, 9, 10, and/or 13.

In some embodiments, a relay device 720-E that is configured to act as a relay for MTC communication, may broadcast one or more discovery signals 1406-A to 1406-N, such as one or more peer discovery signals, to the MTC device 715-I. This may be done by the relay device 720-E periodically or when, for instance, the relay device 720-E detects that an MTC device 715-I is nearby. In other cases, an MTC server 810 may, through the base station 705-F transmit one or more messages 1405 to the relay device 720-E to then forward to the MTC device 715-I. After receiving the message 1405 from the base station 705-F, the relay device 720-E may transmit one or more discovery signals 1406-A to 1406-N to the MTC device 715-I to establish a connection to communicate the information from the base station 705-F to the MTC device 715-I.

In some embodiments, the MTC device 715-I may have data to transmit 1410 prior to, concurrently, or shortly after receipt of the discovery signal(s) 1406 sent from the relay device 720-E. In other cases, the MTC device 715-I might not have data to transmit when or proximate in time to when it receives the discovery signal 1406 from the relay device 720-E. In either case, the MTC device 715-I may then decide to respond 1415 to the discovery request sent by the relay device 720-E to confirm establishment of a link between the MTC device 715-I and the relay device 720-E.

The relay device 720-E may thus discover 1420 the MTC device 715-I, confirm 1430 that it will act as a relay for MTC device 715-I, and establish a link 1435 with the MTC device 715-I, as similarly described above in reference to FIG. 13. Uplink data may then be communicated 1445-A to the relay device 720-E.

At some point in time, the relay device 720-E establishes a link 1425 with the base station 705-F. At this point, the uplink data 1445-A received from the MTC device 715-I can be communicated 1445-B by the relay device 720-E to the base station 705-F, if desired. Additionally, the base station 705-F may communicate on a downlink 1450 directly with the MTC device 715-I. In some cases, the link 1425 established by the relay device 720-E with the base station 705-F may be an example of the link 730 as described above in reference to FIGS. 7, 9, and/or 10. Establishment of the link 1435 between the MTC device 715-I and the relay device 720-E may be an example of the link 745 as also described in reference to FIGS. 7, 9, and/or 10. Routing a confirmation message 1430 by the relay device 720-E to the MTC device 715-I may be accomplished as described above in reference to FIGS. 7 and/or 9.

### Example Apparatus

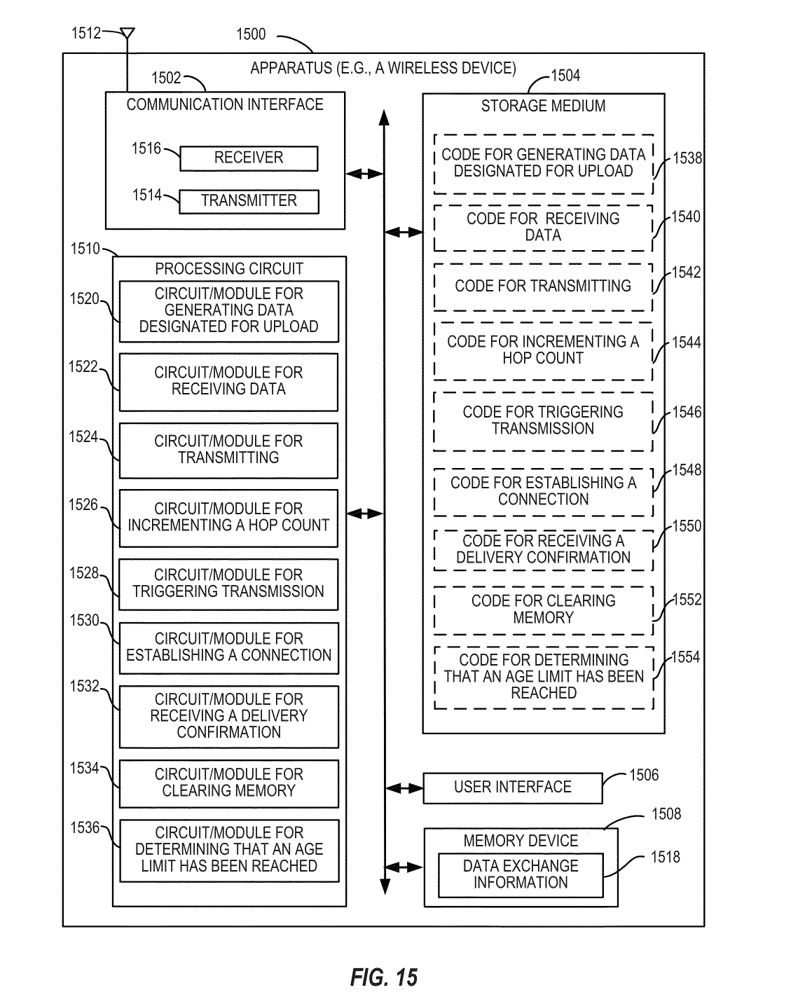

FIG. 15 illustrates a block diagram of an example hardware implementation of an apparatus 1500 configured to communicate according to one or more aspects of the disclosure. For example, the apparatus 1500 could embody or be implemented within an MTC device, a relay device, or some other type of device that supports wireless communication. In various implementations, the apparatus 1500 could embody or be implemented within an access terminal, an access point, or some other type of device. In various implementations, the apparatus 1500 could embody or be implemented within a mobile phone, a smart phone, a tablet, a portable computer, a server, a personal computer, a sensor, and or any other electronic device having circuitry.

The apparatus 1500 includes a communication interface (e.g., at least one transceiver) 1502, a storage medium 1504, a user interface 1506, a memory device (e.g., a memory circuit) 1508, and a processing circuit (e.g., at least one processor) 1510. In various implementations, the user interface 1506 may include one or more of: a keypad, a display, a speaker, a microphone, a touchscreen display, of some other circuitry for receiving an input from or sending an output to a user.

These components can be coupled to and/or placed in electrical communication with one another via a signaling bus or other suitable component, represented generally by the connection lines in FIG. 15. The signaling bus may include any number of interconnecting buses and bridges depending on the specific application of the processing circuit 1510 and the overall design constraints. The signaling bus links together various circuits such that each of the communication interface 1502, the storage medium 1504, the user interface 1506, and the memory device 1508 are coupled to and/or in electrical communication with the processing circuit 1510. The signaling bus may also link various other circuits (not shown) such as timing sources, peripherals, voltage regulators, and power management circuits, which are well known in the art, and therefore, will not be described any further.

The communication interface 1502 provides a means for communicating with other apparatuses over a transmission medium. In some implementations, the communication interface 1502 includes circuitry and/or programming adapted to facilitate the communication of information bi-directionally with respect to one or more communication devices in a network. In some implementations, the communication interface 1502 is adapted to facilitate wireless communication of the apparatus 1500. In these implementations, the communication interface 1502 may be coupled to one or more antennas 1512 as shown in FIG. 15 for wireless communication within a wireless communication system. The communication interface 1502 can be configured with one or more standalone receivers and/or transmitters, as well as one or more transceivers. In the illustrated example, the communication interface 1502 includes a transmitter 1514 and a receiver 1516. The communication interface 1502 serves as one example of a means for receiving and/or means transmitting.

The memory device 1508 may represent one or more memory devices. As indicated, the memory device 1508 may maintain data exchange information 1518 along with other information used by the apparatus 1500. In some implementations, the memory device 1508 and the storage medium 1504 are implemented as a common memory component. The memory device 1508 may also be used for storing data that is manipulated by the processing circuit 1510 or some other component of the apparatus 1500.

The storage medium 1504 may represent one or more computer-readable, machine-readable, and/or processor-readable devices for storing programming, such as processor executable code or instructions (e.g., software, firmware), electronic data, databases, or other digital information. The storage medium 1504 may also be used for storing data that is manipulated by the processing circuit 1510 when executing programming. The storage medium 1504 may be any available media that can be accessed by a general purpose or special purpose processor, including portable or fixed storage devices, optical storage devices, and various other mediums capable of storing, containing or carrying programming.

By way of example and not limitation, the storage medium 1504 may include a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The storage medium 1504 may be embodied in an article of manufacture (e.g., a computer program product). By way of example, a computer program product may include a computer-readable medium in packaging materials. In view of the above, in some implementations, the storage medium 1504 may be a non-transitory (e.g., tangible) storage medium.

The storage medium 1504 may be coupled to the processing circuit 1510 such that the processing circuit 1510 can read information from, and write information to, the storage medium 1504. That is, the storage medium 1504 can be coupled to the processing circuit 1510 so that the storage medium 1504 is at least accessible by the processing circuit 1510, including examples where at least one storage medium is integral to the processing circuit 1510 and/or examples where at least one storage medium is separate from the processing circuit 1510 (e.g., resident in the apparatus 1500, external to the apparatus 1500, distributed across multiple entities, etc.).

Programming stored by the storage medium 1504, when executed by the processing circuit 1510, causes the processing circuit 1510 to perform one or more of the various functions and/or process operations described herein. For example, the storage medium 1504 may include operations configured for regulating operations at one or more hardware blocks of the processing circuit 1510, as well as to utilize the communication interface 1502 for wireless communication utilizing their respective communication protocols.

The processing circuit 1510 is generally adapted for processing, including the execution of such programming stored on the storage medium 1504. As used herein, the terms “code” or “programming” shall be construed broadly to include without limitation instructions, instruction sets, data, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 1510 is arranged to obtain, process and/or send data, control data access and storage, issue commands, and control other desired operations. The processing circuit 1510 may include circuitry configured to implement desired programming provided by appropriate media in at least one example. For example, the processing circuit 1510 may be implemented as one or more processors, one or more controllers, and/or other structure configured to execute executable programming. Examples of the processing circuit 1510 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1510 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1510 are for illustration and other suitable configurations within the scope of the disclosure are also contemplated.

According to one or more aspects of the disclosure, the processing circuit 1510 may be adapted to perform any or all of the features, processes, functions, operations and/or routines for any or all of the apparatuses described herein. For example, the processing circuit 1510 may be configured to perform any of the steps, functions, and/or processes described with respect to FIGS. 1-14 and 16-21. As used herein, the term “adapted” in relation to the processing circuit 1510 may refer to the processing circuit 1510 being one or more of configured, employed, implemented, and/or programmed to perform a particular process, function, operation and/or routine according to various features described herein.

The processing circuit 1510 may be a specialized processor, such as an application specific integrated circuit (ASIC) that serves as a means for (e.g., structure for) carrying out any one of the operations described in conjunction with FIGS. 1-14 and 16-21. The processing circuit 1510 serves as one example of a means for transmitting and/or a means for receiving.

According to at least one example of the apparatus 1500, the processing circuit 1510 may include one or more of a circuit/module for generating data designated for upload 1520, a circuit/module for receiving data 1522, a circuit/module for transmitting 1524, a circuit/module for incrementing a hop count 1526, a circuit/module for triggering transmission 1528, a circuit/module for establishing a connection 1530, a circuit/module for receiving a delivery confirmation 1532, a circuit/module for clearing memory 1534, or a circuit/module for determining that an age limit has been reached 1536.

The circuit/module for generating data designated for upload 1520 may include circuitry and/or programming (e.g., code for generating data designated for upload 1538 stored on the storage medium 1504) adapted to perform several functions relating to, for example, generating first data designated for upload to a wide area network (WAN). Initially, the circuit/module for generating data designated for upload 1520 receives a trigger for generating data. For example, a sensor device may sense a corresponding stimulus and generate an output signal. The circuit/module for generating data designated for upload 1520 then determines whether the resulting data is to be uploaded to a WAN. For example, data from certain sources (e.g., a sensor) may be designated for upload. The circuit/module for generating data designated for upload 1520 then sends the generated data to a component of the apparatus 1500 (e.g., the memory device 1508, the communication interface 1502 or some other component).

The circuit/module for receiving data 1522 may include circuitry and/or programming (e.g., code for receiving data 1540 stored on the storage medium 1504) adapted to perform several functions relating to, for example, receiving second data broadcast on a resource designated for peer devices, wherein the second data is designated for upload to the WAN. Initially, the circuit/module for receiving data 1522 obtains received information. For example, the circuit/module for receiving data 1522 may obtain this information from a component of the apparatus 1500 (e.g., the receiver 1516, the memory device 1508, or some other component) or directly from a device (e.g., an MTC device) that transmitted the information. In some implementations, the circuit/module for receiving data 1522 identifies a memory location of a value in the memory device 1508 and invokes a read of that location. In some implementations, the circuit/module for receiving data 1522 processes (e.g., decodes) the received information. The circuit/module for receiving data 1522 then outputs the received information (e.g., stores the received information in the memory device 1508 or sends the information to another component of the apparatus 1500). In some implementations, the receiver 1516 includes the circuit/module for receiving data 1522 and/or the code for receiving data 1540.

The circuit/module for transmitting 1524 may include circuitry and/or programming (e.g., code for transmitting 1542 stored on the storage medium 1504) adapted to perform several functions relating to, for example, transmitting the first data and the second data via a wireless communication channel. Initially, the circuit/module for transmitting 1524 obtains data to be transmitted. For example, the circuit/module for transmitting 1524 may obtain this data directly from a component of the apparatus (e.g., the memory device 1508 or some other component). In some implementations, the circuit/module for transmitting 1524 processes (e.g., encodes) the data to be transmitted. The circuit/module for transmitting 1524 then causes the data to be transmitted. For example, the circuit/module for transmitting 1524 can pass the data to the transmitter 1514 for subsequent radio frequency (RF) transmission. In some implementations, the transmitter 1514 includes the circuit/module for transmitting 1524 and/or the code for transmitting 1542.

The circuit/module for incrementing a hop count 1526 may include circuitry and/or programming (e.g., code for incrementing a hop count 1544 stored on the storage medium 1504) adapted to perform several functions relating to, for example, incrementing a hop count for the second data prior to the transmission via the wireless communication channel. Initially, the circuit/module for incrementing a hop count 1526 determines the current hop count associated with received data. For example, the circuit/module for incrementing a hop count 1526 may obtain this information from a component of the apparatus 1500 (e.g., the receiver 1516, the memory device 1508, or some other component) or directly from a device (e.g., an MTC device) that transmitted the information. In some implementations, the circuit/module for incrementing a hop count 1526 identifies a memory location of a value in the memory device 1508 and invokes a read of that location. The circuit/module for incrementing a hop count 1526 then increments the current hop count (e.g., increases the value by “1”) to generate a new hop count to be transmitted with the data. The circuit/module for incrementing a hop count 1526 then outputs the incremented value (e.g., stores the received information in the memory device 1508 or sends the value to the transmitter 1514 or another component of the apparatus 1500).

The circuit/module for triggering transmission 1528 may include circuitry and/or programming (e.g., code for triggering transmission 1546 stored on the storage medium 1504) adapted to perform several functions relating to, for example, triggering the transmission of the second data based on at least one criterion, or triggering the transmission of the first data and the second data via the wireless communication channel as a result of the establishment of the connection. Initially, the circuit/module for triggering transmission 1528 obtains at least one criterion (e.g., from the memory device 1508) upon which the trigger is based. In some implementations, the at least one criterion includes at least one of: time slot availability on the resource, a forwarding rule associated with the second data, a hop limit associated with the second data, authentication of the second data, whether the second data was previously transmitted, or availability of memory storage for the second data. In some implementations, the criterion is whether a connection was established (e.g., with a WAN) by the circuit/module for establishing a connection 1530. The circuit/module for triggering transmission 1528 then compares the at least one criterion with a corresponding trigger decision value (e.g., a threshold, a binary test, etc.). The circuit/module for triggering transmission 1528 may then send an indication to a component of the apparatus 1500 (e.g., the transmitter 1514 or some other component) to commence the transmission of data depending on the result of the comparison. In some implementations, the communication interface 1502 includes the circuit/module for triggering transmission 1528 and/or the code for triggering transmission 1546.

The circuit/module for establishing a connection 1530 may include circuitry and/or programming (e.g., code for establishing a connection 1548 stored on the storage medium 1504) adapted to perform several functions relating to, for example, establishing a connection with a WAN. In some implementations, the circuit/module for establishing a connection 1530 communicates with a base station (e.g., an LTE eNB) to establish a connection with a network (e.g., an LTE network). For example, the circuit/module for establishing a connection 1530 may access a base station on a random access channel or some other channel.

The circuit/module for receiving a delivery confirmation 1532 may include circuitry and/or programming (e.g., code for receiving a delivery confirmation 1550 stored on the storage medium 1504) adapted to perform several functions relating to, for example, receiving a delivery confirmation in response to a transmission (e.g., an upload). Initially, the circuit/module for receiving a delivery confirmation 1532 obtains received information. For example, the circuit/module for receiving a delivery confirmation 1532 may obtain this information from a component of the apparatus 1500 (e.g., the receiver 1516, the memory device 1508, or some other component) or directly from a device (e.g., a base station) that transmitted the information. In some implementations, the circuit/module for receiving a delivery confirmation 1532 identifies a memory location of a value in the memory device 1508 and invokes a read of that location. In some implementations, the circuit/module for receiving a delivery confirmation 1532 processes (e.g., decodes) the received information. The circuit/module for receiving a delivery confirmation 1532 then outputs an indication of whether the confirmation has been received (e.g., stores the received information in the memory device 1508 or sends the information to another component of the apparatus 1500). In some implementations, the receiver 1516 includes the circuit/module for receiving a delivery confirmation 1532 and/or the code for receiving a delivery confirmation 1550.

The circuit/module for clearing memory 1534 may include circuitry and/or programming (e.g., code for clearing memory 1552 stored on the storage medium 1504) adapted to perform several functions relating to, for example, clearing memory used for storing data (e.g., the first data or the second data). The memory may be cleared based on one or more triggers (e.g., based on the receipt of the delivery confirmation, or based on a determination that an age limit has been reached). Initially, the circuit/module for clearing memory 1534 receives a trigger (e.g., from the circuit/module for receiving a delivery confirmation 1532 or from the circuit/module for determining that an age limit has been reached 1536). The circuit/module for clearing memory 1534 identifies the memory locations that store the corresponding data and then overwrites or otherwise clears these locations in the memory device 1508.

The circuit/module for determining that an age limit has been reached 1536 may include circuitry and/or programming (e.g., code for determining that an age limit has been reached 1554 stored on the storage medium 1504) adapted to perform several functions relating to, for example, determining that an age limit has been reached, wherein the age limit is for at least one of: the first data or the second data. Initially, the circuit/module for determining that an age limit has been reached 1536 obtains age information associated with stored data. In some implementations, the circuit/module for determining that an age limit has been reached 1536 identifies a memory location for the age information in the memory device 1508 and invokes a read of that location. The circuit/module for determining that an age limit has been reached 1536 then compares the age information with the age limit. The circuit/module for determining that an age limit has been reached 1536 may then send an indication of the result of the comparison (e.g., a yes or no) to a component of the apparatus 1500 (e.g., the memory device 1508, the circuit/module for clearing memory 1534, or some other component).

As mentioned above, programming stored by the storage medium 1504, when executed by the processing circuit 1510, causes the processing circuit 1510 to perform one or more of the various functions and/or process operations described herein. For example, the programming, when executed by the processing circuit 1510, may cause the processing circuit 1510 to perform the various functions, steps, and/or processes described herein with respect to FIGS. 1-14 and 16-21 in various implementations. As shown in FIG. 15, the storage medium 1504 may include one or more of the code for generating data designated for upload 1538, the code for receiving data 1540, the code for transmitting 1542, the code for incrementing a hop count 1544, the code for triggering transmission 1546, the code for establishing a connection 1548, the code for receiving a delivery confirmation 1550, the code for clearing memory 1552, or the code for determining that an age limit has been reached 1554.

### Example Processes

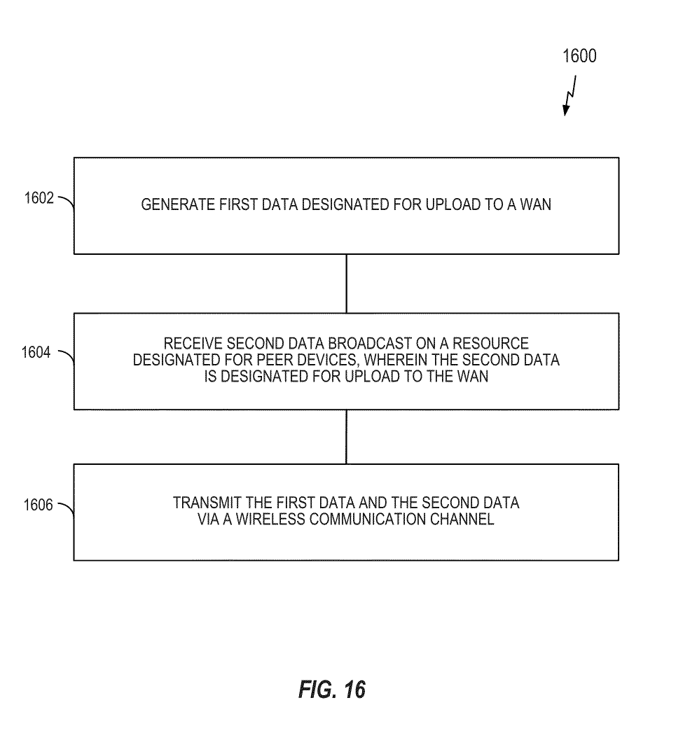

FIG. 16 illustrates a process 1600 for communication in accordance with some aspects of the disclosure. The process 1600 may take place within a processing circuit (e.g., the processing circuit 1510 of FIG. 15), which may be located in an MTC device (e.g., a sensor device, an M2M device, a low power device, etc.), a relay device, or some other suitable apparatus. Of course, in various aspects within the scope of the disclosure, the process 1600 may be implemented by any suitable apparatus capable of supporting mutual data exchange operations (e.g., a mobile device, a base station, etc.).

At block 1602, an apparatus (e.g., an MTC device, a relay device, etc.) generates first data designated for upload to a wide area network (WAN). For example, a sensor device may generate data based on a sensing operation, whereby the sensor data is to be sent to a server connected to the WAN.

At block 1604, the apparatus receives second data broadcast on a resource designated for peer devices. The second data is also designated for upload to the WAN.

For example, a sensor device may receive data sent by other nearby sensor devices on a D2D wireless communication link. In some aspects, the second data may be received via: a Long Term Evolution (LTE) direct link, a Bluetooth link, a ZigBee link, an ad-hoc network link, or a mesh network link.

In some aspects, each of the peer devices may be at least one of: a machine-to-machine (M2M) communication device, a machine type communication (MTC) device, a sensor device, a low power device, a battery operated device, a device with limited radiofrequency (RF) transmit power (e.g., relative to the relay device), a device that includes a radiofrequency (RF) amplifier that has lower RF transmit power than a relay device that uploads the first data and the second data to the WAN, or a device that employs narrow frequency band communication.

The resource may take various forms in different implementations. In some aspects, the resource may include a plurality of time slots designated by a WAN beacon for communication between the peer devices. In some aspects, the resource may include at least one frequency band designated by a WAN beacon for communication between the peer devices.

In some aspects, for each of the first data and the second data, the data includes at least one of: an indication of a source of the data, an indication of a destination for the data, authentication information, a hop count, or a time stamp.

At block 1606, the apparatus transmits the first data and the second data. As discussed below, in some cases, this transmission involves broadcasting the data to the peer devices. Alternatively, in some cases, this transmission involves transmitting the data to the WAN (e.g., directly or via a relay device).

As mentioned above, in some aspects, the transmission includes broadcasting the first data and the second data on the resource designated for peer devices. In some aspects, the transmission involves flooding the resource with the first data and the second data.

In some aspects, a listening and learning procedure may be used on the resource to identify a subset of the resource for the transmission. Alternatively, or in addition, the transmission may involve simply flooding the resource with the data.

Also as mentioned above, in some aspects, the transmission involves sending the first data and the second data to a relay device for relaying of the first data and the second data to the WAN.

In some cases, the peer devices are associated with a first device class and the relay device is associated with a second device class that is different from the first device class. Here, the first device class may include at least one of: a low power class, a low cost class, a low transmit power class, a battery powered class, a small form factor class, an extended battery life class, or a limited power amplifier class.

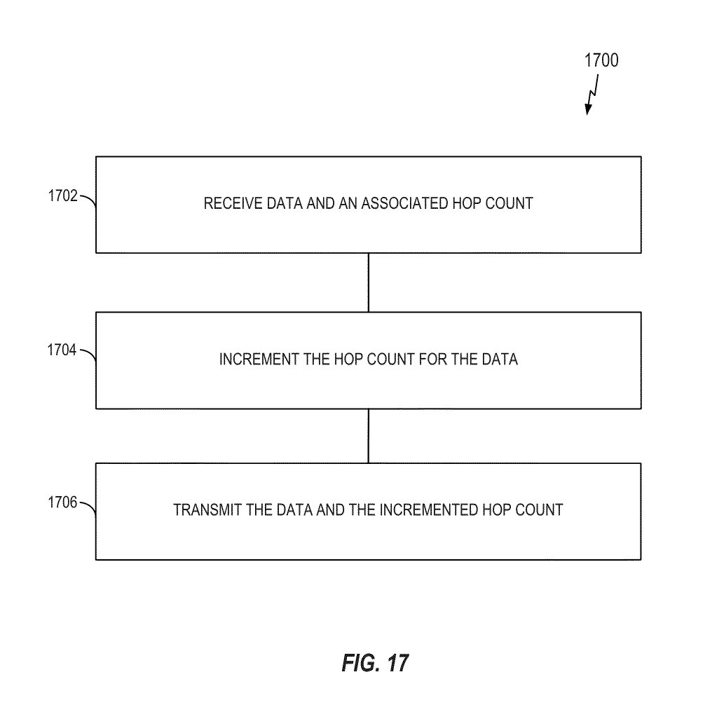

FIG. 17 illustrates a process 1700 relating to incrementing a hop count in accordance with some aspects of the disclosure. In some aspects, the process 1700 may be performed in conjunction with the process 1600 of FIG. 16. The process 1700 may take place within a processing circuit (e.g., the processing circuit 1510 of FIG. 15), which may be located in an MTC device (e.g., a sensor, etc.), a relay device, or some other suitable apparatus. Of course, in various aspects within the scope of the disclosure, the process 1700 may be implemented by any suitable apparatus capable of supporting data exchange operations (e.g., a mobile device, an M2M device, etc.).

In some aspects, the process 1600 may include incrementing a hop count for the second data prior to the transmission (e.g., prior to the rebroadcast of the second data).

At block 1702, an apparatus (e.g., an MTC device) receives data and an associated hop count. For example, a peer device may receive data and an indication of the hop count for the data from another peer device via a D2D channel.

At block 1704, the apparatus increments a hop count for the data. In this way, the hop count now indicates that the data has traversed another hop (to this device).

At block 1706, the apparatus transmits the data and the incremented hop count. For example, the device may re-broadcast the data along with the hop count over the D2D channel.

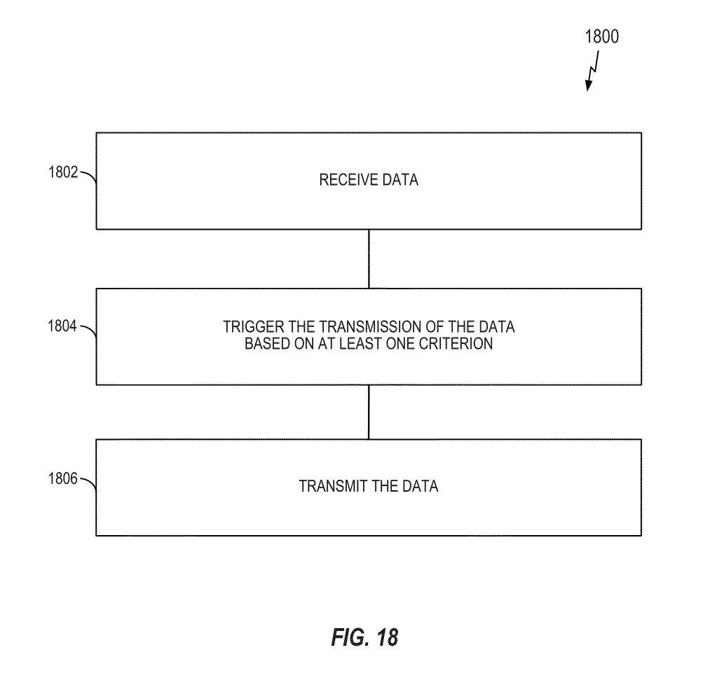

FIG. 18 illustrates a process 1800 relating to triggering the transmission of data in accordance with some aspects of the disclosure. In some aspects, the process 1800 may be performed in conjunction with the process 1600 of FIG. 16. The process 1800 may take place within a processing circuit (e.g., the processing circuit 1510 of FIG. 15), which may be located in an MTC device (e.g., a sensor, etc.), a relay device, or some other suitable apparatus. Of course, in various aspects within the scope of the disclosure, the process 1800 may be implemented by any suitable apparatus capable of supporting data exchange operations (e.g., a mobile device, an M2M device, etc.).

In some aspects, the transmission of the second data may be triggered based on at least one criterion.

At block 1802, an apparatus (e.g., an MTC device, a relay device, etc.) receives data. For example, a peer device may receive data from another peer device via a D2D channel.

At block 1804, transmission of the data by the apparatus is triggered based on at least one criterion. In some aspects, the at least one criterion may include at least one of: time slot availability on the resource, a forwarding rule associated with the second data, a hop limit associated with the second data, authentication of the second data, whether the second data was previously transmitted, or availability of memory storage for the second data.

At block 1806, the apparatus transmits the data. For example, the apparatus may re-broadcast the data over the D2D channel.

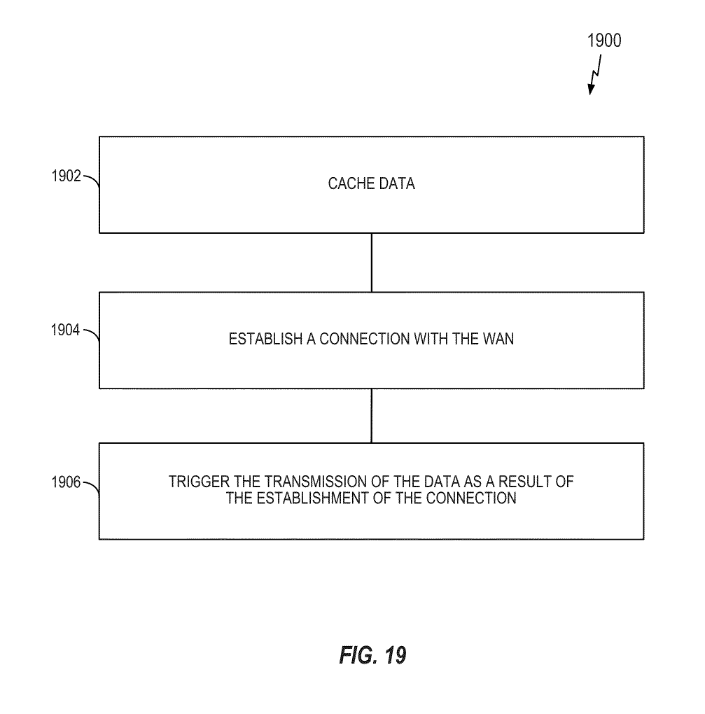

FIG. 19 illustrates a process 1900 relating to triggering data transmission in accordance with some aspects of the disclosure. In some aspects, the process 1900 may be performed in conjunction with the process 1600 of FIG. 16. The process 1900 may take place within a processing circuit (e.g., the processing circuit 1510 of FIG. 15), which may be located in one or more of an MTC device (e.g., a sensor, etc.), a relay device, or some other suitable apparatuses. Of course, in various aspects within the scope of the disclosure, the process 1900 may be implemented by any suitable apparatus capable of supporting data exchange operations (e.g., a mobile device, an M2M device, etc.).

In some aspects, the process 1600 may include establishing a connection with the WAN, wherein the transmission is triggered by the establishment of the connection to the WAN.

At block 1902, an apparatus (e.g., an MTC device, a relay device, etc.) caches data. For example, a peer device or a relay device may cache data received from peer devices via a D2D channel.

At block 1904, the apparatus establishes a connection with a WAN. For example, an MTC device may establish a direct connection with a WAN or establish a connection via a relay device. As another example, a relay device may establish a direct connection with a WAN.

At block 1906, the apparatus triggers the transmission of the data as a result of the establishment of the connection. For example, the device may upload the data as soon as it is able to send the data to the WAN.

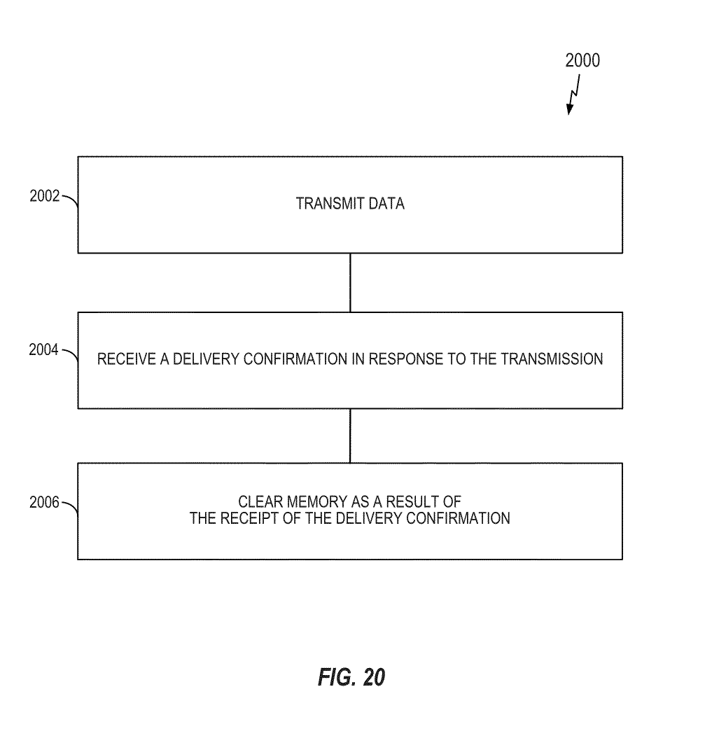

FIG. 20 illustrates a process 2000 relating to clearing memory in accordance with some aspects of the disclosure. In some aspects, the process 2000 may be performed in conjunction with the process 1600 of FIG. 16. The process 2000 may take place within a processing circuit (e.g., the processing circuit 1510 of FIG. 15), which may be located in an MTC device (e.g., a sensor, etc.), a relay device, or some other suitable apparatuses. Of course, in various aspects within the scope of the disclosure, the process 2000 may be implemented by any suitable apparatus capable of supporting aggregation and relaying operations (e.g., a mobile device, an M2M device, etc.).

In some scenarios, a delivery confirmation is received in response to the transmission. In this case, memory used for storing the first data and the second data may be cleared as a result of receiving the delivery confirmation.

At block 2002, an apparatus (e.g., an MTC device, a relay device, etc.) transmits data. For example, a peer device or a relay device may transmit data to a WAN.

At block 2004, the apparatus receives a delivery confirmation in response to the transmission.

At block 2006, the apparatus clears memory used for storing the data as a result of the receipt of the delivery confirmation.

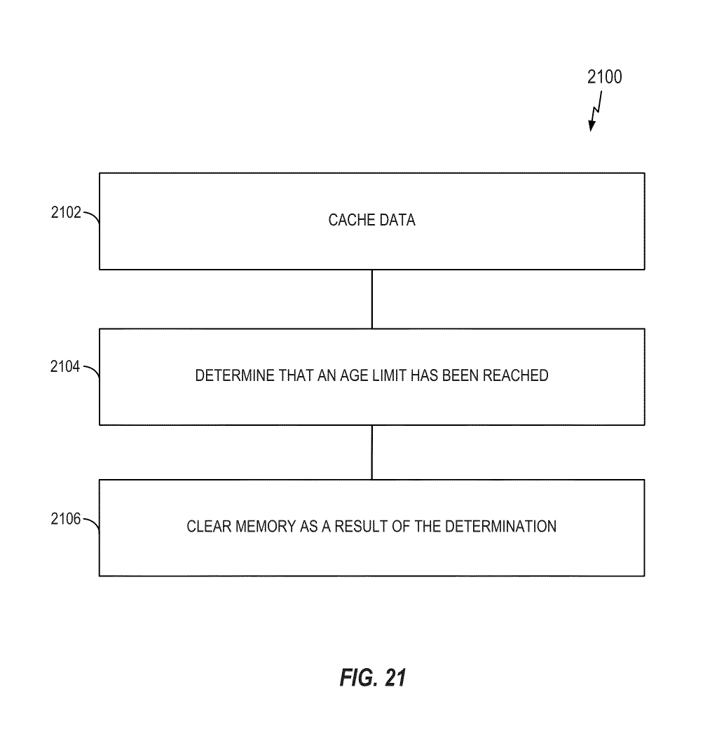

FIG. 21 illustrates a process 2100 relating to clearing memory in accordance with some aspects of the disclosure. In some aspects, the process 2100 may be performed in conjunction with the process 1600 of FIG. 16. The process 2100 may take place within a processing circuit (e.g., the processing circuit 1510 of FIG. 15), which may be located in an MTC device (e.g., a sensor, etc.), a relay device, or some other suitable apparatuses. Of course, in various aspects within the scope of the disclosure, the process 2100 may be implemented by any suitable apparatus capable of supporting data exchange operations (e.g., a mobile device, an M2M device, etc.).

In some scenarios, a determination is made that an age limit (e.g., an expiry time) for the first data and/or the second data has been reached. In this case, memory used for storing the first data and the second data may be cleared as a result of the determination.

At block 2102, an apparatus (e.g., an MTC device, a relay device, etc.) caches data. For example, a peer device or a relay device may cache data received from peer devices via a D2D channel.

At block 2104, the apparatus determines that an age limit of the cached data has been reached.

At block 2106, the apparatus clears memory used for storing the cached data as a result of the determination of block 2104.

### Example Apparatus

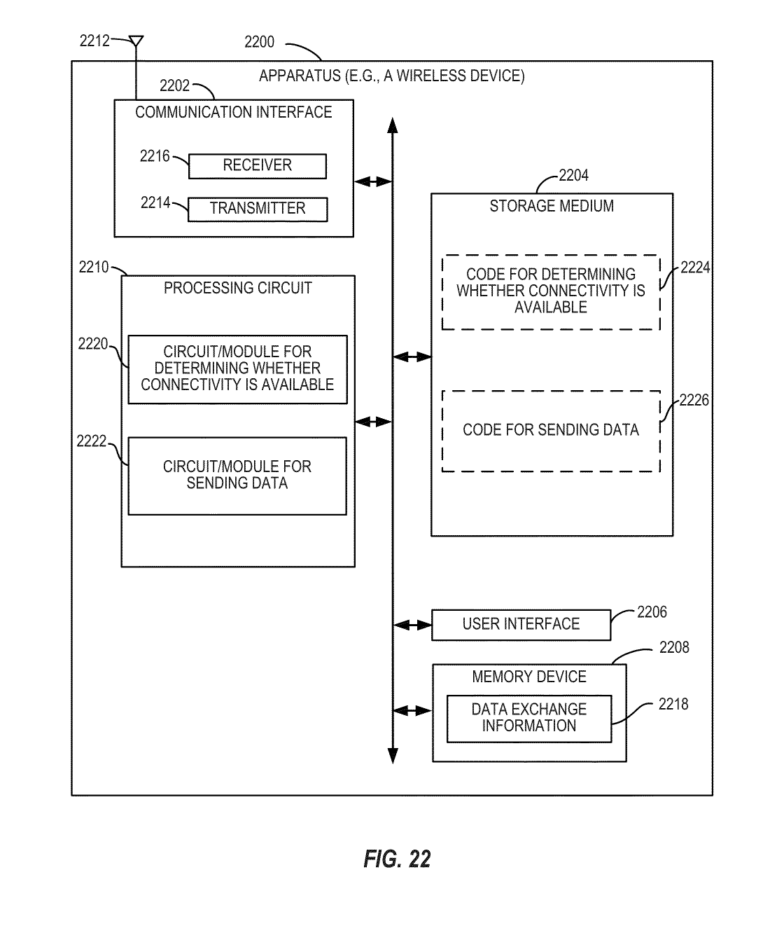

FIG. 22 illustrates a block diagram of an example hardware implementation of an apparatus 2200 configured to communicate according to one or more aspects of the disclosure. For example, the apparatus 2200 could embody or be implemented within an MTC device, a relay device, or some other type of device that supports wireless communication. In various implementations, the apparatus 2200 could embody or be implemented within an access terminal, an access point, or some other type of device. In various implementations, the apparatus 2200 could embody or be implemented within a mobile phone, a smart phone, a tablet, a portable computer, a server, a personal computer, a sensor, and or any other electronic device having circuitry.

The apparatus 2200 includes a communication interface (e.g., at least one transceiver) 2202, a storage medium 2204, a user interface 2206, a memory device 2208 (e.g., storing data exchange information 2218), and a processing circuit (e.g., at least one processor) 2210. In various implementations, the user interface 2206 may include one or more of: a keypad, a display, a speaker, a microphone, a touchscreen display, of some other circuitry for receiving an input from or sending an output to a user. The communication interface 2202 may be coupled to one or more antennas 2212, and may include a transmitter 2214 and a receiver 2216. In general, the components of FIG. 22 may be similar to corresponding components of the apparatus 1500 of FIG. 15.

According to one or more aspects of the disclosure, the processing circuit 2210 may be adapted to perform any or all of the features, processes, functions, operations and/or routines for any or all of the apparatuses described herein. For example, the processing circuit 2210 may be configured to perform any of the steps, functions, and/or processes described with respect to FIGS. 1-14 and 23. As used herein, the term “adapted” in relation to the processing circuit 2210 may refer to the processing circuit 2210 being one or more of configured, employed, implemented, and/or programmed to perform a particular process, function, operation and/or routine according to various features described herein.

The processing circuit 2210 may be a specialized processor, such as an application specific integrated circuit (ASIC) that serves as a means for (e.g., structure for) carrying out any one of the operations described in conjunction with FIGS. 1-14 and 23. The processing circuit 2210 serves as one example of a means for transmitting and/or a means for receiving.

According to at least one example of the apparatus 2200, the processing circuit 2210 may include one or more of a circuit/module for determining whether connectivity is available 2220, or a circuit/module for sending data 2222.

The circuit/module for determining whether connectivity is available 2220 may include circuitry and/or programming (e.g., code for determining whether connectivity is available 2224 stored on the storage medium 2204) adapted to perform several functions relating to, for example, determining whether connectivity for uploading data to a wide area network (WAN) is available. In some implementations, the circuit/module for determining whether connectivity is available 2220 checks a state parameter (e.g., stored in the memory device 2208, in the communication interface 2202, or some other component of the apparatus) for the connectivity status of the apparatus 2200. In some implementations, the circuit/module for determining whether connectivity is available 2220 determines whether the apparatus 2200 has a direct connection to a WAN via a wireless communication channel. In some implementations, the circuit/module for determining whether connectivity is available 2220 determines whether the apparatus 2200 has a connection to a relay device via a peer-to-peer wireless communication channel. The circuit/module for determining whether connectivity is available 2220 sends an indication of the determination (e.g., yes/no and/or type of connectivity) to a component of the apparatus 2200 (e.g., the memory device 1008, the circuit/module for sending data 2222, or some other component).

The circuit/module for sending data 2222 may include circuitry and/or programming (e.g., code for sending data 2226 stored on the storage medium 2204) adapted to perform several functions relating to, for example, sending data to at least one peer device via a peer-to-peer wireless communication channel. In some implementations, the sending of the data is triggered by the determination made by the circuit/module for determining whether connectivity is available 2220 (e.g., data is sent via a peer-to-peer wireless communication channel if WAN connectivity is not available). The circuit/module for sending data 2222 obtains the data to be sent (e.g., from the memory device 2208). The circuit/module for sending data 2222 may then format the data for sending (e.g., in a message, according to a protocol, etc.). The circuit/module for sending data 2222 then causes the data to be sent over the peer-to-peer wireless communication channel. To this end, the circuit/module for sending data 2222 may send the data to the transmitter 2214 or some other component for transmission. In some implementations, the communication interface 2202 includes the circuit/module for sending data 2222 and/or the code for sending data 2226.

As mentioned above, programming stored by the storage medium 2204, when executed by the processing circuit 2210, causes the processing circuit 2210 to perform one or more of the various functions and/or process operations described herein. For example, the programming, when executed by the processing circuit 2210, may cause the processing circuit 2210 to perform the various functions, steps, and/or processes described herein with respect to FIGS. 1-14 and 23 in various implementations. As shown in FIG. 22, the storage medium 2204 may include one or more of the code for determining whether connectivity is available 2224, or the code for sending data 2226.

### Example Process

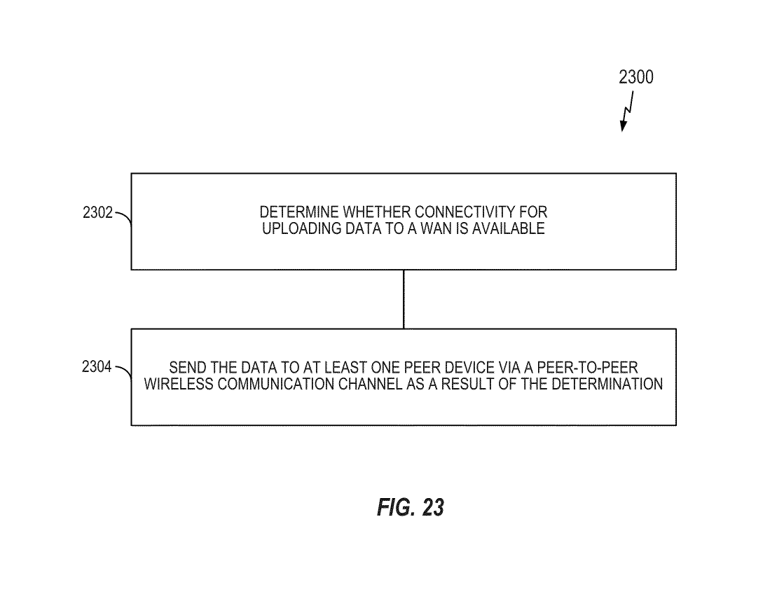

FIG. 23 illustrates a process 2300 for data exchange in accordance with some aspects of the disclosure. The process 2300 may take place within a processing circuit (e.g., the processing circuit 2210 of FIG. 22), which may be located in an MTC device, a relay device, or some other suitable apparatus. Of course, in various aspects within the scope of the disclosure, the process 2300 may be implemented by any suitable apparatus capable of supporting scheduling operations (e.g., a mobile device, an M2M device, etc.).

At block 2302, an apparatus (e.g., an MTC device, a relay device, etc.) determines whether connectivity for uploading data to a WAN is available. For example, an MTC device may determine whether it is able to establish a direct connection with a WAN or establish a connection via a relay device (e.g., via a P2P channel).

At block 2304, the apparatus sends the data to at least one peer device via a peer-to-peer wireless communication channel as a result of the determination of block 2302. For example, a peer device (e.g., as discussed herein) may elect to re-broadcast the data via a D2D channel in the event the peer device is currently unable to upload the data to the WAN. In some aspects, the data comprises a hop count and/or a time stamp.

### Example Apparatus

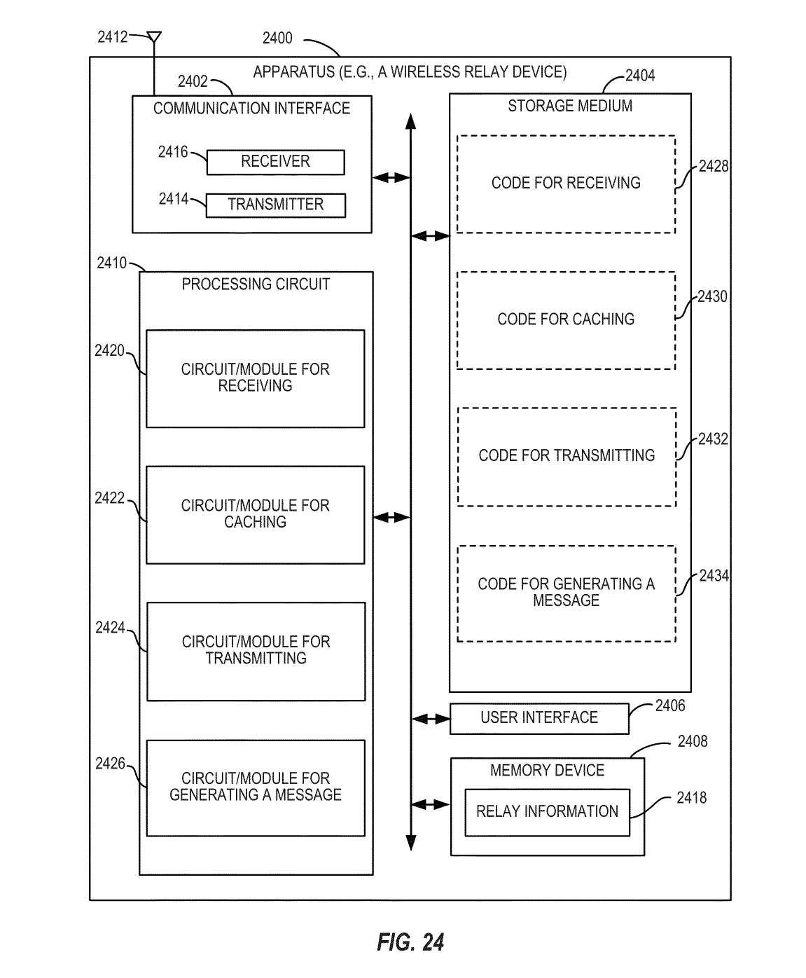

FIG. 24 illustrates a block diagram of an example hardware implementation of an apparatus 2400 configured to communicate according to one or more aspects of the disclosure. For example, the apparatus 2400 could embody or be implemented within a relay device, or some other type of device that supports wireless communication. In various implementations, the apparatus 2400 could embody or be implemented within an access terminal, an access point, or some other type of device. In various implementations, the apparatus 2400 could embody or be implemented within a mobile phone, a smart phone, a tablet, a portable computer, a server, a personal computer, a sensor, and or any other electronic device having circuitry.

The apparatus 2400 includes a communication interface (e.g., at least one transceiver) 2402, a storage medium 2404, a user interface 2406, a memory device 2408 (e.g., storing relay information 2418), and a processing circuit (e.g., at least one processor) 2410. In various implementations, the user interface 2406 may include one or more of: a keypad, a display, a speaker, a microphone, a touchscreen display, of some other circuitry for receiving an input from or sending an output to a user. The communication interface 2402 may be coupled to one or more antennas 2412, and may include a transmitter 2414 and a receiver 2416. In general, the components of FIG. 24 may be similar to corresponding components of the apparatus 1500 of FIG. 15.

According to one or more aspects of the disclosure, the processing circuit 2410 may be adapted to perform any or all of the features, processes, functions, operations and/or routines for any or all of the apparatuses described herein. For example, the processing circuit 2410 may be configured to perform any of the steps, functions, and/or processes described with respect to FIGS. 1-14 and 25. As used herein, the term “adapted” in relation to the processing circuit 2410 may refer to the processing circuit 2410 being one or more of configured, employed, implemented, and/or programmed to perform a particular process, function, operation and/or routine according to various features described herein.

The processing circuit 2410 may be a specialized processor, such as an application specific integrated circuit (ASIC) that serves as a means for (e.g., structure for) carrying out any one of the operations described in conjunction with FIGS. 1-14 and 25. The processing circuit 2410 serves as one example of a means for transmitting and/or a means for receiving.

According to at least one example of the apparatus 2400, the processing circuit 2410 may include one or more of a circuit/module for receiving 2420, a circuit/module for caching 2422, a circuit/module for transmitting 2424, or a circuit/module for generating a message 2426.

The circuit/module for receiving 2420 may include circuitry and/or programming (e.g., code for receiving 2428 stored on the storage medium 2404) adapted to perform several functions relating to, for example, receiving data from a plurality of peer devices via a first wireless communication channel (e.g., a peer-to-peer channel). Initially, the circuit/module for receiving 2420 obtains received information. For example, the circuit/module for receiving 2420 may obtain this information from a component of the apparatus 2400 (e.g., the receiver 2416, the memory device 2408, or some other component) or directly from a device (e.g., an MTC device) that transmitted the information. In some implementations, the circuit/module for receiving 2420 identifies a memory location of a value in the memory device 2408 and invokes a read of that location. In some implementations, the circuit/module for receiving 2420 processes (e.g., decodes) the received information. The circuit/module for receiving 2420 outputs the received information (e.g., stores the received information in the memory device 2408 or sends the information to another component of the apparatus 2400). In some implementations, the receiver 2416 includes the circuit/module for receiving 2420 and/or the code for receiving 2428.

The circuit/module for caching 2422 may include circuitry and/or programming (e.g., code for caching 2430 stored on the storage medium 2404) adapted to perform several functions relating to, for example, caching received data. Initially, the circuit/module for caching 2422 receives the data (e.g., via the receiver 2416). The circuit/module for caching 2422 then stores the data (e.g., in the memory device 1108 or some other component).

The circuit/module for transmitting 2424 may include circuitry and/or programming (e.g., code for transmitting 2432 stored on the storage medium 2404) adapted to perform several functions relating to, for example, transmitting cached data to a wide area network (WAN) via a second wireless communication channel (e.g., a WAN uplink). Initially, the circuit/module for transmitting 2424 obtains the cached data to be transmitted. For example, the circuit/module for transmitting 2424 may obtain this data directly from a component of the apparatus (e.g., the memory device 2408 or some other component). In some implementations, the circuit/module for transmitting 2424 processes (e.g., encodes) the data to be transmitted. The circuit/module for transmitting 2424 then causes the data to be transmitted. For example, the circuit/module for transmitting 2424 can pass the data to the transmitter 2414 for subsequent radio frequency (RF) transmission. In some implementations, the transmitter 2414 includes the circuit/module for transmitting 2424 and/or the code for transmitting 2432.

The circuit/module for generating a message 2426 may include circuitry and/or programming (e.g., code for generating a message 2434 stored on the storage medium 2404) adapted to perform several functions relating to, for example, generating a message including cached data to be uploaded to the WAN. Initially, the circuit/module for generating a message 2426 obtains the cached data. For example, the circuit/module for generating a message 2426 may obtain this data directly from a component of the apparatus (e.g., the memory device 2408 or some other component). In some implementations, the circuit/module for generating a message 2426 processes (e.g., encodes) the data to be transmitted. The circuit/module for generating a message 2426 then formats a message that includes the data. The circuit/module for generating a message 2426 then outputs the message (e.g., to the memory device 2408, the transmitter 2414, or some other component). In some implementations, the transmitter 2414 includes the circuit/module for generating a message 2426 and/or the code for generating a message 2434.

As mentioned above, programming stored by the storage medium 2404, when executed by the processing circuit 2410, causes the processing circuit 2410 to perform one or more of the various functions and/or process operations described herein. For example, the programming, when executed by the processing circuit 2410, may cause the processing circuit 2410 to perform the various functions, steps, and/or processes described herein with respect to FIGS. 1-14 and 25 in various implementations. As shown in FIG. 24, the storage medium 2404 may include one or more of the code for receiving 2428, the code for caching 2430, the code for transmitting 2432, or the code for generating a message 2434.

### Example Process

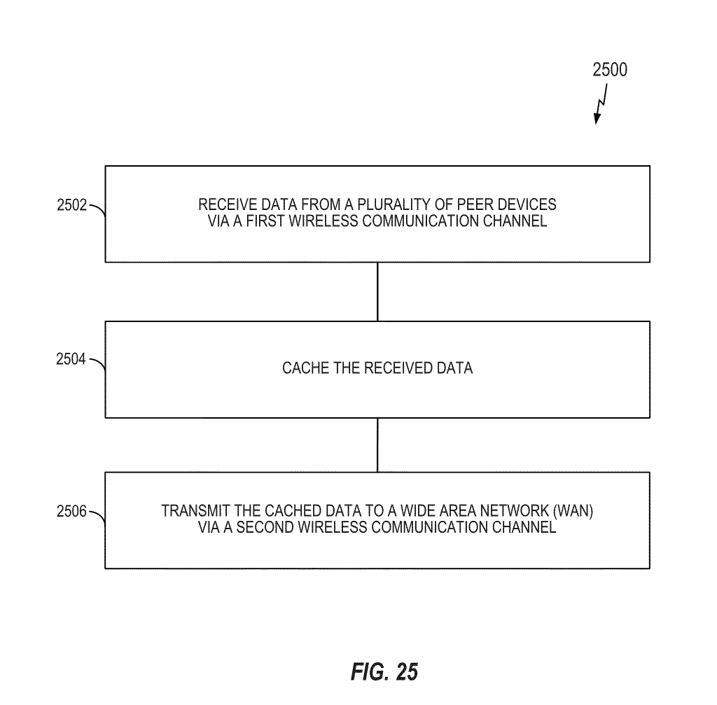

FIG. 25 illustrates a process 2500 for defining a schedule in accordance with some aspects of the disclosure. The process 2500 may take place within a processing circuit (e.g., the processing circuit 2410 of FIG. 24), which may be located in a relay device or some other suitable apparatus. Of course, in various aspects within the scope of the disclosure, the process 2500 may be implemented by any suitable apparatus capable of supporting scheduling operations (e.g., a mobile device, a base station, etc.).

At block 2502, an apparatus (e.g., a relay device) receives data from a plurality of peer devices (e.g., as discussed herein) via a first wireless communication channel. For example, a relay device may receive a communication from a peer device via a D2D (e.g., P2P) channel, where the communication includes data from the peer device and data that the peer device acquired from other peer devices. In some aspects, the data comprises a hop count and/or a time stamp.

At block 2504, the apparatus caches the received data.

At block 2506, the apparatus transmits the cached data to a WAN via a second wireless communication channel. Also, the apparatus may generate a message including the cached data to be uploaded to the WAN. For example, a UE may send the data/message to an eNB via a WAN uplink channel.

### Example Apparatus

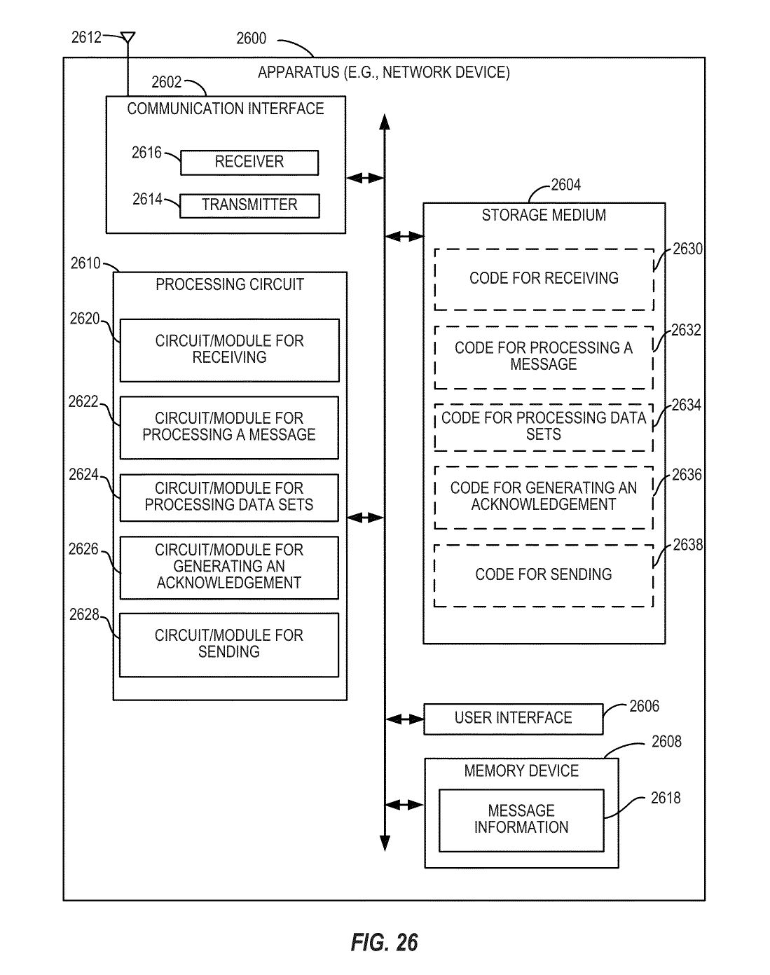

FIG. 26 illustrates a block diagram of an example hardware implementation of an apparatus 2600 configured to communicate according to one or more aspects of the disclosure. For example, the apparatus 2600 could embody or be implemented within a network device (e.g., an eNB, a core network entity, etc.), or some other type of device that supports wireless communication. In various implementations, the apparatus 2600 could embody or be implemented within an access point, or some other type of device. In various implementations, the apparatus 2600 could embody or be implemented within a server, a personal computer, and or any other electronic device having circuitry.

The apparatus 2600 includes a communication interface (e.g., at least one transceiver) 2602, a storage medium 2604, a user interface 2606, a memory device 2608 (e.g., storing message information 2618), and a processing circuit (e.g., at least one processor) 2610. In various implementations, the user interface 2606 may include one or more of: a keypad, a display, a speaker, a microphone, a touchscreen display, of some other circuitry for receiving an input from or sending an output to a user. The communication interface 2602 may be coupled to one or more antennas 2612, and may include a transmitter 2614 and a receiver 2616. In general, the components of FIG. 26 may be similar to corresponding components of the apparatus 1500 of FIG. 15.

According to one or more aspects of the disclosure, the processing circuit 2610 may be adapted to perform any or all of the features, processes, functions, operations and/or routines for any or all of the apparatuses described herein. For example, the processing circuit 2610 may be configured to perform any of the steps, functions, and/or processes described with respect to FIGS. 1-14 and 27-28. As used herein, the term “adapted” in relation to the processing circuit 2610 may refer to the processing circuit 2610 being one or more of configured, employed, implemented, and/or programmed to perform a particular process, function, operation and/or routine according to various features described herein.

The processing circuit 2610 may be a specialized processor, such as an application specific integrated circuit (ASIC) that serves as a means for (e.g., structure for) carrying out any one of the operations described in conjunction with FIGS. 1-14 and 27-28. The processing circuit 2610 serves as one example of a means for transmitting and/or a means for receiving.

According to at least one example of the apparatus 2600, the processing circuit 2610 may include one or more of a circuit/module for receiving 2620, a circuit/module for processing a message 2622, a circuit/module for processing data sets 2624, a circuit/module for generating an acknowledgement 2626, or a circuit/module for sending 2628.

The circuit/module for receiving 2620 may include circuitry and/or programming (e.g., code for receiving 2630 stored on the storage medium 2604) adapted to perform several functions relating to, for example, receiving a message from a relay device via a wireless communication channel, wherein the message includes a plurality of data sets from a plurality of peer devices. Initially, the circuit/module for receiving 2620 obtains received information. For example, the circuit/module for receiving 2620 may obtain this information from a component of the apparatus 2600 (e.g., the receiver 2616, the memory device 2608, or some other component) or directly from an aggregating devices (e.g., an MTC device or a relay device) that transmitted the information. In some implementations, the circuit/module for receiving 2620 identifies a memory location of a value in the memory device 2608 and invokes a read of that location. In some implementations, the circuit/module for receiving 2620 processes (e.g., decodes) the received information. The circuit/module for receiving 2620 outputs the received information (e.g., stores the received information in the memory device 2608 or sends the information to another component of the apparatus 2600). In some implementations, the receiver 2616 includes the circuit/module for receiving 2620 and/or the code for receiving 2630.

The circuit/module for processing a message 2622 may include circuitry and/or programming (e.g., code for processing a message 2632 stored on the storage medium 2604) adapted to perform several functions relating to, for example, processing a message to identify each data set from each peer device. Initially, the circuit/module for processing a message 2622 obtains received information. For example, the circuit/module for processing a message 2622 may obtain this information from a component of the apparatus 2600 (e.g., the receiver 2616, the memory device 2608, or some other component) or directly from the peer devices (e.g., MTC devices) that transmitted the information. In some implementations, the circuit/module for processing a message 2622 identifies a memory location of a value in the memory device 2608 and invokes a read of that location. The circuit/module for processing a message 2622 processes (e.g., decodes) the received information to determine which data in the message corresponds to which peer device (e.g., based on an identifier in the message, the location of the data in the message, etc.). The circuit/module for receiving 2620 then outputs the processed message (e.g., stores the received information in the memory device 2608, sends the information to the circuit/module for processing data sets 2624, or sends the information to another component of the apparatus 2600). In some implementations, the receiver 2616 includes the circuit/module for processing a message 2622 and/or the code for processing a message 2632.

The circuit/module for processing data sets 2624 may include circuitry and/or programming (e.g., code for processing data sets 2634 stored on the storage medium 2604) adapted to perform several functions relating to, for example, individually processing each of the data sets from a received message. Initially, the circuit/module for processing data sets 2624 obtains message information output by the circuit/module for processing a message 2622. For example, the circuit/module for processing data sets 2624 may obtain this information directly from the circuit/module for processing a message 2622 or from another component of the apparatus 2600 (e.g., the receiver 2616, the memory device 2608, or some other component). In some implementations, the circuit/module for processing data sets 2624 identifies a memory location of a value in the memory device 2608 and invokes a read of that location. The circuit/module for processing data sets 2624 processes (e.g., decodes) each data set in the received information. In some implementations, the processing includes determining whether each data set was successfully received (e.g., without error). In some implementations, the processing includes identifying a charging policy for each data set in a message. The circuit/module for processing data sets 2624 then outputs a result of the processing (e.g., stores the data set information in the memory device 2608 or sends the data set information to another component of the apparatus 2600). In some implementations, the receiver 2616 includes the circuit/module for processing data sets 2624 and/or the code for processing data sets 2634.

The circuit/module for generating an acknowledgement 2626 may include circuitry and/or programming (e.g., code for generating an acknowledgement 2636 stored on the storage medium 2604) adapted to perform several functions relating to, for example, for each data set, generate an acknowledgement for the data set. Initially, the circuit/module for generating an acknowledgement 2626 obtains data information output by the circuit/module for processing data sets 2624. For example, the circuit/module for generating an acknowledgement 2626 may obtain this information directly from the circuit/module for processing data sets 2624 or from another component of the apparatus 2600 (e.g., the memory device 2608, or some other component). In some implementations, the circuit/module for generating an acknowledgement 2626 identifies a memory location of a value in the memory device 2608 and invokes a read of that location. The circuit/module for generating an acknowledgement 2626 generates an acknowledgement (e.g., an ACK or NAK) that indicates where a given data set was successfully received. The circuit/module for processing data sets 2624 then outputs the acknowledgment (e.g., stores the acknowledgment in the memory device 2608, sends the acknowledgment to the transmitter 2614, or sends the acknowledgment to another component of the apparatus 2600). In some implementations, the communication interface 2602 includes the circuit/module for generating an acknowledgement 2626 and/or the code for generating an acknowledgement 2636.

The circuit/module for sending 2628 may include circuitry and/or programming (e.g., code for sending 2638 stored on the storage medium 2604) adapted to perform several functions relating to, for example, sending acknowledgements via a wireless communication channel. Initially, the circuit/module for sending 2628 obtains acknowledgement information (e.g., from the memory device 2608, the circuit/module for generating an acknowledgement 2626, or some other component). The circuit/module for sending 2628 may then format the data for sending (e.g., in a message, according to a protocol, etc.). The circuit/module for sending 2628 then sends causes the data to be sent via the wireless communication channel. To this end, the circuit/module for sending 2628 may send the data to the transmitter 2614 or some other component for transmission. In some implementations, the transmitter 2614 includes the circuit/module for sending 2628 and/or the code for sending 2638.

As mentioned above, programming stored by the storage medium 2604, when executed by the processing circuit 2610, causes the processing circuit 2610 to perform one or more of the various functions and/or process operations described herein. For example, the programming, when executed by the processing circuit 2610, may cause the processing circuit 2610 to perform the various functions, steps, and/or processes described herein with respect to FIGS. 1-14 and 27-28 in various implementations. As shown in FIG. 26, the storage medium 2604 may include one or more of the code for receiving 2630, the code for processing a message 2632, the code for processing data sets 2634, the code for generating an acknowledgement 2636, or the code for sending 2638.

### Example Processes

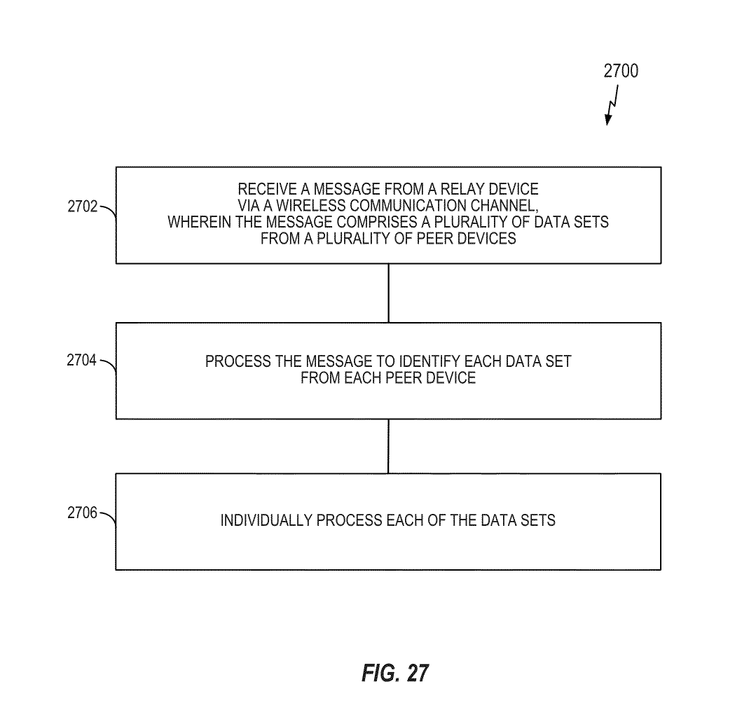

FIG. 27 illustrates a process 2700 for processing messages in accordance with some aspects of the disclosure. The process 2700 may take place within a processing circuit (e.g., the processing circuit 2610 of FIG. 26), which may be located in a network entity or some other suitable apparatus. Of course, in various aspects within the scope of the disclosure, the process 2700 may be implemented by any suitable apparatus capable of supporting message processing operations (e.g., a base station, etc.).

At block 2702, an apparatus (e.g., a network device) receives a message from a relay device via a wireless communication channel (e.g., a WAN UL channel). This message includes a plurality of data sets from a plurality of peer devices (e.g., a first data set from a first peer device, a second data set from a second peer device, etc.). For example, an eNB may receive a message from a UE that is serving as a relay for a set of MTC devices.

At block 2704, the apparatus processes the message to identify each data set from each peer device. For example, the device may use identifiers associated with each data set to identify the originating peer device for that data set.

At block 2706, the apparatus individually processes each of the data sets. For example, for each data set, the device may identify a charging policy for the data set.

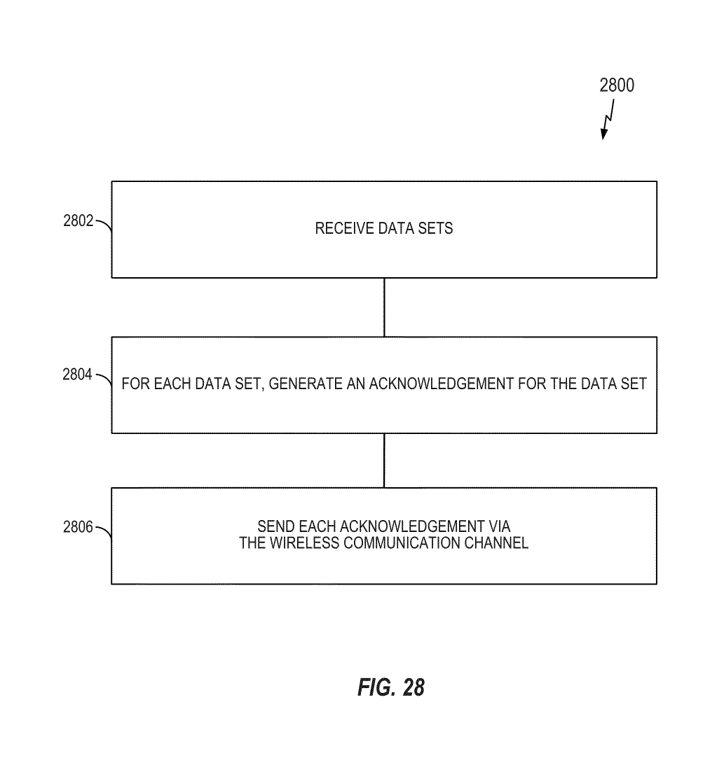

FIG. 28 illustrates a process 2800 for processing messages in accordance with some aspects of the disclosure. In some aspects, the process 2800 may be performed in conjunction with the process 2700 of FIG. 27. The process 2800 may take place within a processing circuit (e.g., the processing circuit 2610 of FIG. 26), which may be located in a network entity or some other suitable apparatus. Of course, in various aspects within the scope of the disclosure, the process 2800 may be implemented by any suitable apparatus capable of supporting message processing operations (e.g., a base station, etc.).

At block 2802, an apparatus (e.g., a network device) receives data sets. This operation may correspond in some aspects to the operation of block 2702 of FIG. 27.

At block 2804, for each data set, the apparatus generates an acknowledgement to acknowledge receipt of the data set.

At block 2806, the apparatus sends each acknowledgement via the wireless communication channel. For example, the device may send the acknowledgments via a WAN downlink channel.

### Example Apparatus

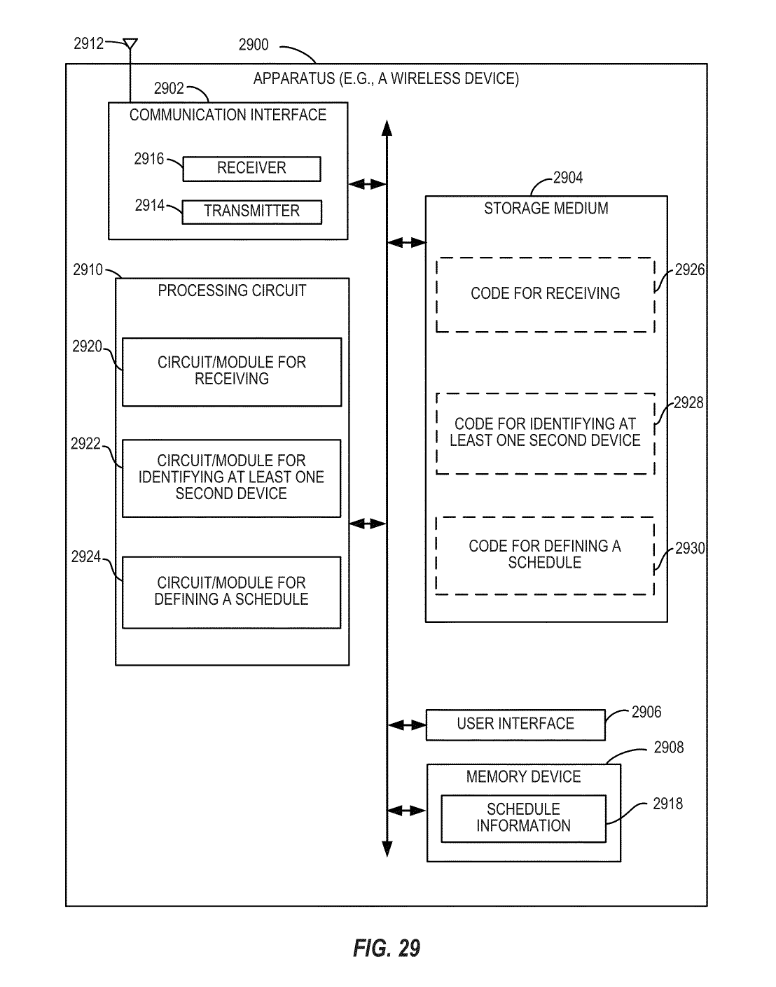

FIG. 29 illustrates a block diagram of an example hardware implementation of an apparatus 2900 configured to communicate according to one or more aspects of the disclosure. For example, the apparatus 2900 could embody or be implemented within an MTC device, a relay device, or some other type of device that supports wireless communication. In various implementations, the apparatus 2900 could embody or be implemented within an access terminal, an access point, or some other type of device. In various implementations, the apparatus 2900 could embody or be implemented within a mobile phone, a smart phone, a tablet, a portable computer, a server, a personal computer, a sensor, and or any other electronic device having circuitry.

The apparatus 2900 includes a communication interface (e.g., at least one transceiver) 2902, a storage medium 2904, a user interface 2906, a memory device 2908 (e.g., storing schedule information 2918), and a processing circuit (e.g., at least one processor) 2910. In various implementations, the user interface 2906 may include one or more of: a keypad, a display, a speaker, a microphone, a touchscreen display, of some other circuitry for receiving an input from or sending an output to a user. The communication interface 1502 may be coupled to one or more antennas 2912, and may include a transmitter 2914 and a receiver 2916. In general, the components of FIG. 29 may be similar to corresponding components of the apparatus 1500 of FIG. 15.

According to one or more aspects of the disclosure, the processing circuit 2910 may be adapted to perform any or all of the features, processes, functions, operations and/or routines for any or all of the apparatuses described herein. For example, the processing circuit 2910 may be configured to perform any of the steps, functions, and/or processes described with respect to FIGS. 1-14 and 30. As used herein, the term “adapted” in relation to the processing circuit 2910 may refer to the processing circuit 2910 being one or more of configured, employed, implemented, and/or programmed to perform a particular process, function, operation and/or routine according to various features described herein.

The processing circuit 2910 may be a specialized processor, such as an application specific integrated circuit (ASIC) that serves as a means for (e.g., structure for) carrying out any one of the operations described in conjunction with FIGS. 1-14 and 30. The processing circuit 2910 serves as one example of a means for transmitting and/or a means for receiving.

According to at least one example of the apparatus 2900, the processing circuit 2910 may include one or more of a circuit/module for receiving 2920, a circuit/module for identifying at least one second device 2922, or a circuit/module for defining a schedule 2924.

The circuit/module for receiving 2920 may include circuitry and/or programming (e.g., code for receiving 2930 stored on the storage medium 2904) adapted to perform several functions relating to, for example, receiving signals at a first device. Initially, the circuit/module for receiving 2920 obtains received signals. For example, the circuit/module for receiving 2920 may obtain these signals from a component of the apparatus 2900 (e.g., the receiver 2916, the memory device 2908, or some other component) or directly from peer devices (e.g., MTC devices) that transmitted the information. In some implementations, the circuit/module for receiving 2920 processes (e.g., decodes) the received signals. The circuit/module for receiving 2920 outputs the received signals (e.g., sends the signals to the circuit/module for identifying at least one second device 2922, stores received signal information in the memory device 2908, or sends the information to another component of the apparatus 2900). In some implementations, the receiver 2916 includes the circuit/module for receiving 2920 and/or the code for receiving 2926.

The circuit/module for identifying at least one second device 2922 may include circuitry and/or programming (e.g., code for identifying at least one second device 2928 stored on the storage medium 1104) adapted to perform several functions relating to, for example, identifying, based on the received signals, at least one second device belonging to at least one specified device class. Initially, the circuit/module for identifying at least one second device 2922 obtains the received signals (e.g., from the circuit/module for receiving 2920). The circuit/module for identifying at least one second device 2922 processes the received signals to identify the device or devices that transmitted the signals (e.g., based on identification information encoded in the signals). The circuit/module for identifying at least one second device 2922 then outputs an indication of the identified device(s) to a component of the apparatus 2900 (e.g., to the memory device 2908, the circuit/module for defining a schedule 2924 or some other component).

The circuit/module for defining a schedule 2924 may include circuitry and/or programming (e.g., code for defining a schedule 2930 stored on the storage medium 2604) adapted to perform several functions relating to, for example, for each data set, generate an acknowledgement for the data set. Initially, the circuit/module for defining a schedule 2924 obtains data information output by the circuit/module for identifying at least one second device 2922. For example, the circuit/module for defining a schedule 2924 may obtain this information directly from the circuit/module for identifying at least one second device 2922 or from another component of the apparatus 2600 (e.g., the memory device 2608, or some other component). In some implementations, the circuit/module for defining a schedule 2924 identifies a memory location of a value in the memory device 2608 and invokes a read of that location. The circuit/module for defining a schedule 2924 generates a schedule (e.g., time slots and/or frequency bands) for each of the second devices and the apparatus 2900 (e.g., to enable orthogonal communication). The circuit/module for defining a schedule 2924 outputs the schedule (e.g., stores the schedule in the memory device 2608, sends the schedule to the transmitter 2614, or sends the schedule to another component of the apparatus 2600).

As mentioned above, programming stored by the storage medium 2904, when executed by the processing circuit 2910, causes the processing circuit 2910 to perform one or more of the various functions and/or process operations described herein. For example, the programming, when executed by the processing circuit 2910, may cause the processing circuit 2910 to perform the various functions, steps, and/or processes described herein with respect to FIGS. 1-14 and 30 in various implementations. As shown in FIG. 29, the storage medium 2904 may include one or more of the code for receiving 2926, the code for identifying at least one second device 2928, or the code for defining a schedule 2930.

### Example Process

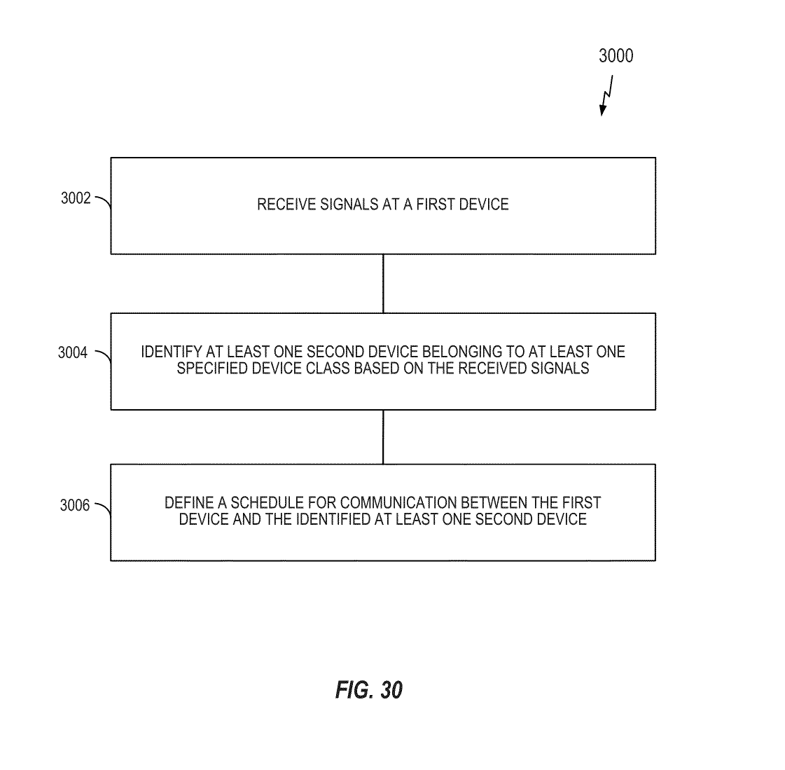

FIG. 30 illustrates a process 3000 for defining a schedule in accordance with some aspects of the disclosure. The process 3000 may take place within a processing circuit (e.g., the processing circuit 2910 of FIG. 29), which may be located in a low power device (e.g., a sensor device, an M2M device, an MTC device, etc.) or some other suitable apparatus. Of course, in various aspects within the scope of the disclosure, the process 3000 may be implemented by any suitable apparatus capable of supporting scheduling operations (e.g., a mobile device, a base station, etc.).

At block 3002, signals are received at a first device. For example, a sensor may monitor for signals transmitted by other sensors.

At block 3004, at least one second device belonging to at least one specified device class is identified based on the received signals. For example, the sensor may identify one or more nearby sensors as a result of the monitoring of block 3002. In some aspects, the identification of the at least one second device involves determining a quantity of peer devices within a defined proximity.

In some aspects, each of the first device and the at least one second device may be: a machine-to-machine (M2M) communication device, a machine type communication (MTC) device, a sensor device, a low power device, a battery operated device, a device that includes a radiofrequency (RF) amplifier that has lower RF transmit power than a relay device that uploads data to a WAN, or a device that employs narrow frequency band communication.

In some aspects, the at least one specified device class may include at least one of: a low power class, a low cost class, a low transmit power class, a battery powered class, a small form factor class, an extended battery life class, or a limited power amplifier class.

At block 3006, a schedule is defined for communication between the first device and the identified at least one second device. For example, the first device and the at least one second device may cooperate to define the schedule. As another example, one of these devices may unilaterally define the schedule.

In some aspects, the definition of the schedule involves determining how to exchange data between the first device and the at least one second device. In some aspects, the definition of the schedule involves determining how far to exchange data among the first device and the at least one second device. In some aspects, the definition of the schedule involves synchronizing the schedule to timing for a wide area network (WAN).

In some aspects, the definition of the schedule involves identifying a subset of resources designated for device-to-device communication in a wide area network (WAN). In some aspects, the resources include a plurality of time slots designated by a WAN beacon for communication between peer devices. In some aspects, the resources include a plurality of frequency bands designated by a WAN beacon for communication between peer devices.

In some aspects, the communication is via: a Long Term Evolution (LTE) direct link, a Bluetooth link, a ZigBee link, an ad-hoc network link, or a mesh network link.

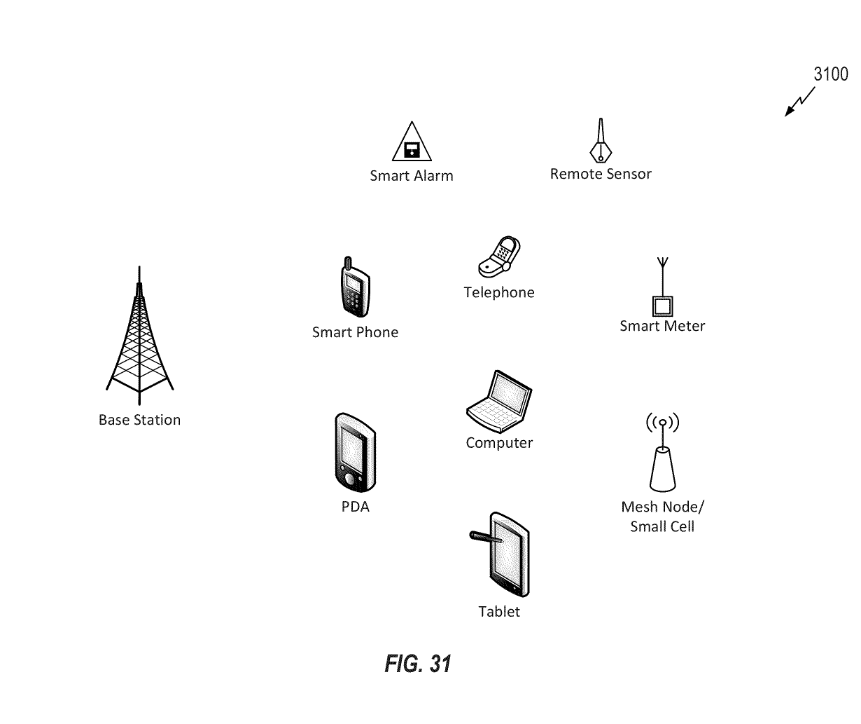

FIG. 31 is a schematic illustration of a wireless communication network 3100 including multiple communication entities as it may appear in some aspects of the disclosure. As described herein, a scheduling entity or an entity being scheduled may reside in, or be a part of, a base station, a smart phone, a small cell, or other entity. Subordinate entities or mesh nodes may reside in, or be a part of, a smart alarm, a remote sensor, a smart phone, a telephone, a smart meter, a personal data assistant (PDA), a personal computer, a mesh node, and/or a tablet computer. Of course, the illustrated devices or components are merely exemplary in nature, and any suitable node or device may appear within a wireless communication network within the scope of the present disclosure.

### ADDITIONAL ASPECTS

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while example implementations may have been discussed herein as device, system, or method implementations, it should be understood that such example implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” or “one or more of” a list of items refers to any combination of those items, including single members. As an example, “at least one of: a, b, or c” is intended to cover: a; b; c; a and b; a and c; b and c; a, b and c; 2a; 2b; 2c; 2a and b; a and 2b, 2a and 2b; and so on. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Accordingly, the various features associate with the examples described herein and shown in the accompanying drawings can be implemented in different examples and implementations without departing from the scope of the disclosure. Therefore, although certain specific constructions and arrangements have been described and shown in the accompanying drawings, such implementations are merely illustrative and not restrictive of the scope of the disclosure, since various other additions and modifications to, and deletions from, the described implementations will be apparent to one of ordinary skill in the art. Thus, the scope of the disclosure is only determined by the literal language, and legal equivalents, of the claims which follow.

What is claimed is:

1. An apparatus for communication, comprising:
a processing circuit configured to generate first data designated for upload to a wide area network (WAN);
a receiver coupled to the processing circuit and configured to receive second data broadcast on a resource designated for peer devices, wherein the second data is designated for upload to the WAN; and
a transmitter coupled to the processing circuit and configured to transmit the first data and the second data via a wireless communication channel.

2. The apparatus of claim 1, wherein each of the peer devices comprises at least one of: a machine-to-machine (M2M) communication device, a machine type communication (MTC) device, or a sensor device.

3. The apparatus of claim 1, wherein each of the peer devices includes a radiofrequency (RF) amplifier that has lower RF transmit power than a relay device that uploads the first data and the second data to the WAN.

4. The apparatus of claim 1, wherein the receiver is further configured to receive the second data via: a Long Term Evolution (LTE) direct link, a Bluetooth link, a ZigBee link, an ad-hoc network link, or a mesh network link.

5. The apparatus of claim 1, wherein, for each of the first data and the second data, the data comprises at least one of: a hop count or a time stamp.

6. The apparatus of claim 1, wherein, to transmit the first data and the second data via the wireless communication channel, the transmitter is further configured to:
broadcast the first data and the second data on the resource designated for peer devices.

7. The apparatus of claim 6, wherein the processing circuit is further configured to:
increment a hop count for the second data prior to the transmission via the wireless communication channel.

8. The apparatus of claim 6, wherein, to transmit the first data and the second data via the wireless communication channel, the transmitter is further configured to:
flood the resource with the first data and the second data.

9. The apparatus of claim 1, wherein the processing circuit is further configured to:
trigger the transmission of the second data based on at least one criterion.

10. The apparatus of claim 9, wherein the at least one criterion comprises at least one of: time slot availability on the resource, a forwarding rule associated with the second data, a hop limit associated with the second data, authentication of the second data, whether the second data was previously transmitted, or availability of memory storage for the second data.

11. The apparatus of claim 1, wherein, to transmit the first data and the second data via the wireless communication channel, the transmitter is further configured to:
send the first data and the second data to a relay device for relaying of the first data and the second data to the WAN.

12. The apparatus of claim 11, wherein the processing circuit is further configured to:
establish a connection with the WAN; and
trigger the transmission of the first data and the second data via the wireless communication channel as a result of the establishment of the connection.

13. The apparatus of claim 11, wherein:
the peer devices are associated with a first device class; and
the relay device is associated with a second device class that is different from the first device class.

14. The apparatus of claim 13, wherein the first device class comprises at least one of: a power class, a cost class, a transmit power class, a battery powered class, a form factor class, a battery life class, or a power amplifier class.

15. The apparatus of claim 1, wherein the wireless communication channel is a WAN uplink channel.

16. The apparatus of claim 15, wherein:
the peer devices are associated with a first device class; and
the apparatus comprises a relay device that is associated with a second device class that is different from the first device class.

17. The apparatus of claim 1, wherein the resource comprises a plurality of time slots designated by a WAN beacon for communication between the peer devices.

18. The apparatus of claim 1, wherein the resource comprises at least one frequency band designated by a WAN beacon for communication between the peer devices.

19. The apparatus of claim 1, wherein the processing circuit is further configured to:
receive a delivery confirmation in response to the transmission; and
clear memory as a result of the receipt of the delivery confirmation, wherein the memory is used for storing at least one of: the first data or the second data.

20. The apparatus of claim 1, wherein the processing circuit is further configured to:
determine that an age limit has been reached, wherein the age limit is for at least one of: the first data or the second data; and
clear memory as a result of the determination, wherein the memory is used for storing at least one of: the first data or the second data.

21. A method of communication for an apparatus, comprising:
generating first data designated for upload to a wide area network (WAN);
receiving second data broadcast on a wireless communication resource designated for peer devices, wherein the second data is designated for upload to the WAN; and
transmitting the first data and the second data via a wireless communication channel.

22. The method of claim 21, wherein each of the peer devices comprises at least one of: a machine-to-machine (M2M) communication device, a machine type communication (MTC) device, or a sensor device.

23. The method of claim 21, wherein each of the peer devices includes a radiofrequency (RF) amplifier that has lower RF transmit power than a relay device that uploads the first data and the second data to the WAN.

24. The method of claim 21, wherein the transmission via the wireless communication channel comprises:
broadcasting the first data and the second data on the resource designated for peer devices.

25. The method of claim 24, further comprising:
incrementing a hop count for the second data prior to the transmission via the wireless communication channel.

26. The method of claim 21, further comprising:
triggering the transmission of the second data based on at least one criterion.

27. The method of claim 26, wherein the at least one criterion comprises at least one of: time slot availability on the resource, a forwarding rule associated with the second data, a hop limit associated with the second data, authentication of the second data, whether the second data was previously transmitted, or availability of memory storage for the second data.

28. The method of claim 21, wherein the transmission via the wireless communication channel comprises:
sending the first data and the second data to a relay device for relaying of the first data and the second data to the WAN.

29. The method of claim 28, wherein:
the peer devices are associated with a first device class; and
the relay device is associated with a second device class that is different from the first device class.

30. The method of claim 29, wherein the first device class comprises at least one of: a power class, a cost class, a transmit power class, a battery powered class, a form factor class, a battery life class, or a power amplifier class.

31. The method of claim 21, wherein the wireless communication channel is a WAN uplink channel.

32. The method of claim 31, wherein:
the peer devices are associated with a first device class; and
the apparatus comprises a relay device that is associated with a second device class that is different from the first device class.

33. The method of claim 21, further comprising:
receiving a delivery confirmation in response to the transmission; and
clearing memory as a result of the receipt of the delivery confirmation, wherein the memory is used for storing the first data and the second data.

34. The method of claim 21, further comprising:
determining that an age limit has been reached, wherein the age limit is for at least one of: the first data or the second data; and
clearing memory as a result of the determination, wherein the memory is used for storing at least one of: the first data or the second data.

35. An apparatus for communication, comprising:
means for generating first data designated for upload to a wide area network (WAN);
means for receiving second data broadcast on a resource designated for peer devices, wherein the second data is designated for upload to the WAN; and
means for transmitting the first data and the second data via a wireless communication channel.

36. The apparatus of claim 35, further comprising:
means for triggering the transmission of the second data based on at least one criterion.

37. The apparatus of claim 35, further comprising:
means for incrementing a hop count for the second data prior to the transmission via the wireless communication channel.

38. The apparatus of claim 35, further comprising:
means for receiving a delivery confirmation in response to the transmission; and
means for clearing memory as a result of the receipt of the delivery confirmation, wherein the memory is used for storing the first data and the second data.

39. The apparatus of claim 35, further comprising:
means for determining that an age limit has been reached, wherein the age limit is for at least one of: the first data or the second data; and
means for clearing memory as a result of the determination, wherein the memory is used for storing at least one of: the first data or the second data.

40. A non-transitory computer-readable medium storing computer-executable code, including code to:
generate first data designated for upload to a wide area network (WAN);
receive second data broadcast on a resource designated for peer devices, wherein the second data is designated for upload to the WAN; and
transmit the first data and the second data via a wireless communication channel.

41. An apparatus for communication, comprising:
a memory device; and
a processing circuit coupled to the memory device and configured to:
determine whether connectivity for uploading data to a wide area network (WAN) is available; and
send the data to at least one peer device via a peer-to-peer wireless communication channel as a result of the determination.

42. The apparatus of claim 41, wherein, to determine whether the connectivity is available, the processing circuit is further configured to:
determine whether the apparatus has a direct connection to the WAN via a wireless communication channel.

43. The apparatus of claim 41, wherein, to determine whether the connectivity is available, the processing circuit is further configured to:
determine whether the apparatus has a connection to a relay device via the peer-to-peer wireless communication channel.

44. The apparatus of claim 41, wherein each peer device comprises at least one of: a machine-to-machine (M2M) communication device, a machine type communication (MTC) device, a sensor device, or a device that includes a radiofrequency (RF) amplifier that has lower RF transmit power than a relay device that uploads the data to the WAN.

45. The apparatus of claim 41, wherein the data comprises at least one of: a hop count or a time stamp.

46. A method of communication for an apparatus, comprising:
determining whether connectivity for uploading data to a wide area network (WAN) is available; and
sending the data to at least one peer device via a peer-to-peer wireless communication channel as a result of the determination.

47. The method of claim 46, wherein the determination of whether the connectivity is available comprises:
determining whether the apparatus has a direct connection to the WAN via a wireless communication channel.

48. The method of claim 46, wherein the determination of whether the connectivity is available comprises:
determining whether the apparatus has a connection to a relay device via the peer-to-peer wireless communication channel.

49. An apparatus for communication, comprising:
means for determining whether connectivity for uploading data to a wide area network (WAN) is available; and
means for sending the data to at least one peer device via a peer-to-peer wireless communication channel as a result of the determination.

50. A non-transitory computer-readable medium storing computer-executable code, including code to:
determine whether connectivity for uploading data to a wide area network (WAN) is available; and
send the data to at least one peer device via a peer-to-peer wireless communication channel as a result of the determination.

51. An apparatus for communication, comprising:
a receiver configured to receive data from a plurality of peer devices via a first wireless communication channel;
a processing circuit coupled to the receiver and configured to cache the received data; and
a transmitter coupled to the processing circuit and configured to transmit the cached data to a wide area network (WAN) via a second wireless communication channel.

52. The apparatus of claim 51, wherein:
the first wireless communication channel is a peer-to-peer wireless communication channel; and
the second wireless communication channel is a WAN uplink channel.

53. The apparatus of claim 51, wherein the processing circuit is further configured to:
generate a message comprising the cached data to be uploaded to the WAN.

54. The apparatus of claim 51, wherein each peer device comprises at least one of: a machine-to-machine (M2M) communication device, a machine type communication (MTC) device, a sensor device, or a device that includes a radiofrequency (RF) amplifier that has lower RF transmit power than a relay device that uploads the data to the WAN.

55. The apparatus of claim 51, wherein the data received from each peer device comprises at least one of: a hop count or a time stamp.

56. A method of communication for an apparatus, comprising:
receiving data from a plurality of peer devices via a first wireless communication channel;
caching the received data; and
transmitting the cached data to a wide area network (WAN) via a second wireless communication channel.

57. The method of claim 56, wherein:
the first wireless communication channel is a peer-to-peer wireless communication channel; and
the second wireless communication channel is a WAN uplink channel.

58. The method of claim 56, further comprising:
generating a message comprising the cached data to be uploaded to the WAN.

59. An apparatus for communication, comprising:
means for receiving data from a plurality of peer devices via a first wireless communication channel;
means for caching the received data; and
means for transmitting the cached data to a wide area network (WAN) via a second wireless communication channel.

60. A non-transitory computer-readable medium storing computer-executable code, including code to:
receive data from a plurality of peer devices via a first wireless communication channel;
cache the received data; and
transmit the cached data to a wide area network (WAN) via a second wireless communication channel.

61. An apparatus for communication, comprising:
a memory device; and
a processing circuit coupled to the memory device and configured to:
receive a message from a relay device via a wireless communication channel, wherein the message comprises a plurality of data sets from a plurality of peer devices;
process the message to identify each data set from each peer device; and
individually process each of the data sets.

62. The apparatus of claim 61, wherein, to individually process each of the data sets, the processing circuit is further configured to:
for each data set, identify a charging policy for the data set.

63. The apparatus of claim 61, wherein the processing circuit is further configured to:
for each data set, generate an acknowledgement for the data set; and
send each acknowledgement via the wireless communication channel.

64. The apparatus of claim 61, wherein the wireless communication channel is a WAN uplink channel.

65. The apparatus of claim 61, wherein each peer device comprises at least one of: a machine-to-machine (M2M) communication device, a machine type communication (MTC) device, a sensor device, or a device that includes a radiofrequency (RF) amplifier that has lower RF transmit power than a relay device that transmits the message.

66. A method of communication for an apparatus, comprising:
receiving a message from a relay device via a wireless communication channel, wherein the message comprises a plurality of data sets from a plurality of peer devices;
processing the message to identify each data set from each peer device; and
individually processing each of the data sets.

67. The method of claim 66, wherein the individually processing each of the data sets further comprises:
for each data set, identifying a charging policy for the data set.

68. The method of claim 66, further comprising:
for each data set, generating an acknowledgement for the data set; and
sending each acknowledgement via the wireless communication channel.

69. An apparatus for communication, comprising:
means for receiving a message from a relay device via a wireless communication channel, wherein the message comprises a plurality of data sets from a plurality of peer devices;
means for processing the message to identify each data set from each peer device; and
means for individually processing each of the data sets.

70. A non-transitory computer-readable medium storing computer-executable code, including code to:
receive a message from a relay device via a wireless communication channel, wherein the message comprises a plurality of data sets from a plurality of peer devices;
process the message to identify each data set from each peer device; and
individually process each of the data sets.

71. An apparatus for communication, comprising:
a memory device; and
a processing circuit coupled to the memory device and configured to:
receive signals at a first device;
identify at least one second device belonging to at least one specified device class based on the received signals; and
define a schedule for communication between the first device and the identified at least one second device.

72. The apparatus of claim 71, wherein the at least one specified device class comprises at least one of: a power class, a cost class, a transmit power class, a battery powered class, a form factor class, a battery life class, or a power amplifier class.

73. The apparatus of claim 71, wherein each of the first device and the at least one second device comprises at least one of: a machine-to-machine (M2M) communication device, a machine type communication (MTC) device, or a sensor device.

74. The apparatus of claim 71, wherein each of the first device and the at least one second device includes a radiofrequency (RF) amplifier that has lower RF transmit power than a relay device that uploads data from the first device and the identified at least one second device to a wide area network (WAN).

75. The apparatus of claim 71, wherein the communication is via: a Long Term Evolution (LTE) direct link, a Bluetooth link, a ZigBee link, an ad-hoc network link, or a mesh network link.

76. The apparatus of claim 71, wherein, to define the schedule, the processing circuit is further configured to determine how to exchange data between the first device and the at least one second device.

77. The apparatus of claim 71, wherein, to define the schedule, the processing circuit is further configured to determine how far to exchange data among the first device and the at least one second device.

78. The apparatus of claim 71, wherein, to define the schedule, the processing circuit is further configured to synchronize the schedule to timing for a wide area network (WAN).

79. The apparatus of claim 71, wherein, to define the schedule, the processing circuit is further configured to identify a subset of resources designated for device-to-device communication in a wide area network (WAN).

80. The apparatus of claim 79, wherein the resources comprise a plurality of time slots designated by a WAN beacon for communication between peer devices.

81. The apparatus of claim 79, wherein the resources comprise a plurality of frequency bands designated by a WAN beacon for communication between peer devices.

82. The apparatus of claim 71, wherein, to identify the at least one second device, the processing circuit is further configured to determine quantity of peer devices within a defined proximity.

83. A method of communication, comprising:
receiving signals at a first device;
identifying at least one second device belonging to at least one specified device class based on the received signals; and
defining a schedule for communication between the first device and the identified at least one second device.

84. The method of claim 83, wherein the definition of the schedule comprises determining how to exchange data between the first device and the at least one second device.

85. The method of claim 83, wherein the definition of the schedule comprises determining how far to exchange data among the first device and the at least one second device.

86. The method of claim 83, wherein the definition of the schedule comprises synchronizing the schedule to timing for a wide area network (WAN).

87. The method of claim 83, wherein the definition of the schedule comprises identifying a subset of resources designated for device-to-device communication in a wide area network (WAN).

88. The method of claim 83, wherein the identification of the at least one second device comprises determining a quantity of peer devices within a defined proximity.

89. An apparatus for communication, comprising:
means for receiving signals at a first device;
means for identifying at least one second device belonging to at least one specified device class based on the received signals; and
means for defining a schedule for communication between the first device and the identified at least one second device.

90. A non-transitory computer-readable medium storing computer-executable code, including code to:
receive signals at a first device;
identify at least one second device belonging to at least one specified device class based on the received signals; and
define a schedule for communication between the first device and the identified at least one second device.
